(19) United States
(12) Patent Application Publication
(10) Pub. No.: US 2004/0030653 A1
(43) Pub. Date: Feb. 12, 2004

(54) Intellectual property rights management system

(76) Inventor: Maren Christensen, Marina del Roy, CA (US)

Correspondence Address: SHELDON & MAK, INC, 225 SOUTH LAKE AVENUE, 9TH FLOOR, PASADENA, CA, 91101, US

(21) Appl. No.: 10/416,283

(22) PCT Filed: Nov. 8, 2001
(86) PCT No.: PCT/US01/49919

(51) Int. Cl. G06F 17/60

(52) U.S. Cl. 705/51

(57) ABSTRACT

A system for managing intellectual property rights (24) in an intellectual property arising from one or more contract documents (12), comprising a central procession unit (26), a display device (28) coupled to the central processing unit, one or more rights questionnaires (10) posing one or more questions pertains to the intellectual property, a first memory (30) coupled to the central processing unit (26) for storing a management program (22) comprising a packaging module (14) for packaging the contract documents (12) and the rights questionnaires (10), a review module (16) for directing review of the contract documents and acquisition of acquired responses to the questions posed in the rights questionnaires (10), and a search module (20) to allow searching of the acquired responses, a second memory (32) coupled to the central processing unit (26) for storing the rights questionnaires (10), and a third memory (34) coupled to the central processing unit (26) for storing the acquire responses.

### CROSS-REFERENCE TO RELATED APPLICATIONS

The present Application claims the benefit of U.S. Provisional Patent Application No. 60/247,508 titled “Intellectual Property Management System” filed Nov. 10, 2000; the contents of which are incorporated by reference in this disclosure in their entirety.

### LIMITED COPYRIGHT WAIVER

A portion of this patent document contains material in which a claim of copyright protection is made. The copyright owner has no objection to the reproduction of the patent document for review as it appears in the files and records of the U.S. Patent and Trademark Office, but reserves all other rights.

### BACKGROUND

The present invention relates to a database management system, and more particularly, to a system for collecting and updating intellectual property rights information throughout a company in a timely manner, and communicating the information to users in a meaningful format.

One of the most difficult challenges facing a company is the cataloging and maintenance of its intellectual property. Proper understanding of the extent of a company's patent, trademark and copyright portfolio can make the difference between success and failure of the enterprise. The proper collection of information is complicated by the multiplicity of rights that are inherent even within a single copyright, trademark, or patent. Coupled with the essential need to calendar critical dates associated with intellectual property, such as renewal dates, maintenance fee dates, and the like, the task can quickly overwhelm a company.

Moreover, accurate information regarding a company's intellectual property portfolio is essential for planning of all potential uses of the properties, thereby maximizing the use of these assets, and helping to avoid costly and disruptive litigation over rights. Intellectual property rights information for a company is usually fragmented. The information which is potentially the most valuable to the business for planning purposes, or to enhance sales and marketing, may not exist in a central location in a consistent and useable manner, if it exists at all. Existing systems capture only a fraction of pertinent rights information.

Manual systems to catalog intellectual property rights have been in use, and follow a paradigm of a card catalog. These all have a failing of being susceptible to error and mis-filed entries, leading to disastrous loss of intellectual property rights. Moreover, these are generally limited to mere catalogs of titles, without any attempt to mine the extent of the rights owned, which requires legal analysis of each property.

Attempts have been made to utilize the benefits of computerization for the task of managing intellectual property rights, but these have merely been little more than computerized card catalogs. Generally these systems take a property oriented approach, requiring the operator to first determine what intellectual property rights exist, and then permitting operator entry into a database of information regarding that property. What is missing from such systems is an integrated system of questions designed to elicit critical information about the component intellectual property rights, with a comprehensive inquiry mechanism to allow the appropriate people within the company to determine the scope and extent of their holdings.

In any system for management of intellectual property rights consideration should be given to appropriate protections for privileged attorney-client communications and attorney work product. A system structure that facilitates such protection would be desirable.

Further, such a system would preferably be both project and property oriented, generating questions appropriate for both projects and for underlying properties. A system that would capture rights information related to films and other products, properties underlying the films and related projects, and enable management to monitor rights for timeliness, clarity and consistency standards would maximize revenues through exploitation and development of properties and aid in managing legal costs from litigation. By creation of a set of standard rights summaries a company could develop a process which would enhance its ability to exploit and protect its intellectual property assets. Insufficient attention to rights management may result in the loss of millions of dollars of revenue opportunities.

A desirable system would capture information both on a company's library of intellectual property titles and on products and projects in development, so that the same facts would only have to be recited once and so information could be captured as early as possible. The advantages of early capture are great. For example, divisions responsible for exploiting downstream opportunities for new theatrical films, such as merchandising, would be able to make deals as early as possible. In addition to generating additional revenues in such a direct way, this would also increase productivity as those responsible for making the various deals necessary to create the theatrical picture would not be tied up answering phone calls regarding the status of various deals. Instead of relying upon “institutional knowledge,” captured only in the memories of individuals, information could be found in the system. Creating standard rules and procedures for setting up and maintaining title information, and creating an easy-to-use process for querying the entire company product inventory, would be a key purpose of the system. This would also increase reliability since the information was presented in writing in one form making it less likely to be mis-translated.

What is needed, therefore, is an intellectual property rights management system using a computer based interface to pose questions designed to elicit critical information about intellectual property rights, answered by those who have the best understanding of the rights acquired, with a comprehensive inquiry mechanism to allow authorized individuals to determine the scope and extent of their holdings, being project and product oriented, thereby generating questions appropriate for a project or product, without requiring an operator to first determine what rights exist.

### SUMMARY

The present invention meets this need by providing a system for managing intellectual property rights in an intellectual property arising from one or more than one contract document, comprising a central processing unit, a display device coupled to the central processing unit, one or more than one rights questionnaire posing one or more than one question pertaining to the intellectual property, a first memory coupled to the central processing unit for storing a management program, the management program comprising a packaging module for packaging the one or more than one contract document and the one or more than one rights questionnaire, a review module for directing review of the one or more than one contract document and acquisition of acquired responses to the one or more than one question posed in the one or more than one rights questionnaire, and a search module to allow searching of the acquired responses, a second memory coupled to the central processing unit for storing the one or more than one rights questionnaire, and a third memory coupled to the central processing unit for storing the acquired responses. Thus, a system is provided for managing intellectual property rights comprising a computer-based information handling system to perform steps for managing ownership rights in an intellectual property arising from one or more than one contract document, and a computer readable medium containing a management program.

In a further embodiment, the management program further comprises an approval module for permitting one or more than one review of the acquired responses.

In a preferred embodiment, the rights questionnaire comprises one or more than one document checklist, one or more than one rights summary and one or more than one copyright summary. In a further preferred embodiment, the one or more than one rights summary comprises one or more than one underlying rights summary and one or more than one distribution rights summary. In a further preferred embodiment, the one or more than one copyright summary comprises one or more than one product copyright summary and one or more than one underlying work copyright summary.

In a preferred embodiment, at least one rights questionnaire comprises at least one question arising under a law chosen from the group consisting of copyright laws, trademark laws, and patent laws. Additionally, optionally the management program further comprises a privilege access module for controlling the disclosure of the acquired responses.

Additionally, optionally the system further comprises a fourth memory coupled to the central processing unit for storing the one or more than one contract document.

In one embodiment, the packaging module comprises an initialization module for initializing the system and creating one or more than one record having information pertaining to the intellectual property, a linkage module for linking two or more records pertaining to the intellectual property to each other, a generation module for generating the one or more than one appropriate rights questionnaire, a routing module for sending the one or more than one contract document and the one or more than one generated rights questionnaire to the review module, and a hierarchical tree to represent the linkage between the records.

In another embodiment, the linkage module further links one or more than one record pertaining to the intellectual property to one or more than one record pertaining to other intellectual property. In another embodiment, the management program stores the records created by the initialization module into a first database. In a further embodiment, the linkage module links one or more than one record to one or more than one rights questionnaire.

The system can be used by a packager operating the packaging module, a reviewer operating the reviewing module, and a searcher operating the search module. Optionally, the packager and searcher are the same person. In one embodiment, the reviewer is an attorney within a corporate legal department. In another embodiment, the reviewer is an attorney in an outside law firm.

Optionally, the generation module can automatically generate one or more than one rights questionnaires when the initialization module creates one or more than one new record. In a further embodiment, the generation module offers a choice of rights questionnaires and generates the one or more than one rights questionnaires chosen.

A system is provided for managing intellectual property rights in an intellectual property arising from one or more than one contract document, comprising means for central processing, means for display coupled to the mean for central processing, means for posing legal questions pertaining to the intellectual property, means for storing a management program coupled to the means for central processing, the management program comprising, means for packaging the one or more than one contract document and the legal questions, means for reviewing the one or more than one contract document and acquiring acquired responses to the legal questions, and means for searching the acquired responses.

A method for managing intellectual property rights in an intellectual property arising from one or more than one contract document, is described comprising the steps of packaging the one or more than one contract document and pertinent legal questions comprising one or more than one legal question pertaining to the intellectual property, directing the review of the one or more than one contract document and acquisition of acquired responses to the pertinent legal questions, and storing the acquired responses in a database to permit searching the acquired responses. In one embodiment, packaging step comprises the steps of initializing a management program and creating data records comprising one or more than one data record having information pertaining to the intellectual property, generating the pertinent legal questions, linking the data records to the pertinent legal questions, displaying a hierarchical tree representing the linkage between the data records and the pertinent legal questions; and routing the one or more than one contract document, the pertinent legal questions, and the data records to the review module.

In one embodiment, the generating step comprises offering a choice of rights questionnaires, receiving a request for one or more than one rights questionnaire, and generating the one or more than one rights questionnaire requested. Additionally, optionally the generating step comprises automatically generating one or more than one rights questionnaire based upon the information in the data records.

In one embodiment, before the packaging step, one or more than one rights questionnaire is prepared having one or more than one question designed to elicit critical information about ownership rights in intellectual property.

In one embodiment, the directing step comprises sending the one or more than one contract document to a legal source for review and receiving acquired responses to the pertinent legal questions.

A method for managing intellectual property rights in an intellectual property arising from one or more than one contract document, is provided comprising the steps for central processing and display of information pertinent to the intellectual property, posing legal questions pertaining to the intellectual property, storing a management program used in the central processing and display step, the management program comprising the steps for, packaging the one or more than one contract document and the legal questions, reviewing the one or more than one contract document and acquiring acquired responses to the legal questions, and searching the acquired responses.

A method for managing ownership rights in an intellectual property arising from one or more than one contract document is described, comprising the steps of, under the control of a user system, accessing a computer network, initializing a management program and creating data records and preparing a package having one or more than one rights questionnaire and the one or more than one contract document, routing the package for review, the rights questionnaire having one or more than one question, and receiving a reviewed rights questionnaire having responses to the one or more than one question and storing the responses in a database. In a further embodiment, the step of searching the responses stored in the database may be added.

A signal for transmitting computer information through a computer network for causing a computer-based information handling system to perform steps for managing ownership rights in an intellectual property arising from one or more than one contract document is provided, the steps comprising, packaging the one or more than one contract document and pertinent legal questions comprising one or more than one legal question pertaining to the intellectual property, directing the review of the one or more than one contract document and acquisition of acquired responses to the pertinent legal questions, and storing the acquired responses in a database to permit searching the acquired responses.

### FIGURES

These and other features, aspects, and advantages of the present invention will become better understood with reference to the following description, appended claims, and accompanying drawings, where:

FIG. 1 is a component diagram of a management program useable in the system of FIG. 2.

FIG. 2 is a system diagram of the intellectual property management system of the present invention.

FIG. 3 is a component diagram showing a preferred embodiment of a rights questionnaire useable in the management program of FIG. 1.

FIG. 4 is an exemplar of a document checklist useable as a rights questionnaire in the management program of FIG. 1.

FIG. 5 is an exemplar of a portion of an underlying rights summary useable as a rights questionnaire in the management program of FIG. 1.

FIG. 6 is an exemplar of a portion of a distribution rights summary useable as a rights questionnaire in the management program of FIG. 1.

FIG. 7 is an exemplar of a portion of a product copyright summary useable as a rights questionnaire in the management program of FIG. 1.

FIG. 8 is an exemplar of a portion of an underlying work copyright summary (pre-1978) useable as a rights questionnaire in the management program of FIG. 1.

FIG. 9 is a component diagram of a packaging module useable in the management program of FIG. 1.

FIG. 10 is an exemplar of a hierarchical tree useable in the packaging module of FIG. 9.

FIG. 11 is a flow chart of the procedure implemented to create the hierarchical tree of FIG. 10.

FIG. 12 is a screen shot of a menu window displayed by one embodiment of the management program of FIG. 1.

FIG. 13 is a screen shot of a window displayed by one embodiment of the management program of FIG. 1.

FIG. 14 is a screen shot of a window displayed by one embodiment of the management program of FIG. 1.

FIG. 15 is a screen shot of a window displayed by one embodiment of the management program of FIG. 1.

FIG. 16 is a screen shot of a window displayed by one embodiment of the management program of FIG. 1.

FIG. 17 is a screen shot of a window displayed by one embodiment of the management program of FIG. 1.

FIG. 18 is a screen shot of a window displayed by one embodiment of the management program of FIG. 1.

FIG. 19 is a screen shot of a window displayed by one embodiment of the management program of FIG. 1.

FIG. 21 is a screen shot of a window displayed by one embodiment of the management program of FIG. 1.

FIG. 22 is a screen shot of a window displayed by one embodiment of the management program of FIG. 1.

FIG. 23 is a screen shot of a window displayed by one embodiment of the management program of FIG. 1.

FIG. 24 is a screen shot of a window displayed by one embodiment of the management program of FIG. 1.

FIG. 25 is a screen shot of a window displayed by one embodiment of the management program of FIG. 1.

FIG. 26 is a screen shot of a window displayed by one embodiment of the management program of FIG. 1.

FIG. 27 is a screen shot of a window displayed by one embodiment of the management program of FIG. 1.

FIG. 28 is a screen shot of a window displayed by one embodiment of the management program of FIG. 1.

FIG. 29 is a flow diagram of a process useable in one embodiment of the review module of FIG. 1.

FIG. 30 is a component diagram of an intellectual property package generated by one embodiment of the packaging module of FIG. 1.

FIG. 31 is a screen shot of a window displayed by one embodiment of the management program of FIG. 1.

FIG. 32 is a screen shot of a window displayed by one embodiment of the management program of FIG. 1.

FIG. 33 is a flow diagram of a process useable in one embodiment of the approval module of FIG. 1.

FIG. 34 is a screen shot of a window displayed by one embodiment of the management program of FIG. 1.

FIG. 35 is a screen shot of a window displayed by one embodiment of the management program of FIG. 1.

FIG. 36 is a screen shot of a window displayed by one embodiment of the management program of FIG. 1.

FIG. 37 is a screen shot of a window displayed by one embodiment of the management program of FIG. 1.

FIG. 38 is a screen shot of a window displayed by one embodiment of the management program of FIG. 1.

FIG. 39 is an object diagram of the access permitted by one embodiment of the privilege access module of FIG. 1.

### DESCRIPTION

The present invention is directed to a system for determining and managing intellectual property rights. In a preferred embodiment described herein, the system is implemented in a corporation engaged in the entertainment industry, covering copyright information, the right of publicity and contract based rights. As noted below, modifications in the system can be easily made by those skilled in the art to cover allied intellectual property rights such as patent rights, and would be readily adaptable to other industry, research facilities, or educational institutions.

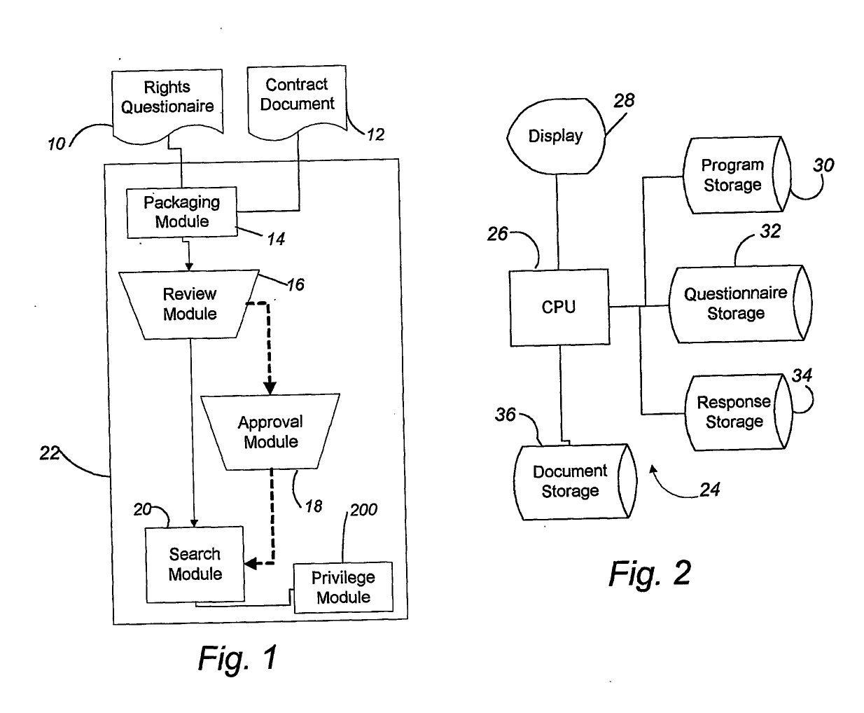

With reference to FIG. 1, a management program 22 for managing intellectual property rights is provided comprising a packaging module 14 for packaging one or more than one contract document 12 and one or more than one previously prepared rights questionnaire 10, a review module 16 for handling review of the contract document 12 and answering the questions posed in the one or more than one rights questionnaire 10, and a search module 20 to allow searching of the responses to previously stored one or more than one rights questionnaire 10. Optionally, management program 22 may further comprise an approval module 18 to permit one or more reviews of the responses to the one or more than one rights questionnaire 10 before implementation of application of the search module 20.

With reference to FIG. 2, an intellectual property management system 24 is provided comprising a CPU 26, a display 28, a first memory 30 for storing the management program 22, a second memory 32 for storing the one or more than one rights questionnaire 10, a third memory 34 for storing the responses to the one or more than one rights questionnaire 10, and optionally a fourth memory 36 for storing the one or more than one contract document 12.

As will be evident to those skilled in the art with reference to this disclosure, it will be possible to implement an intellectual property management system 24 using one or more than one CPU 26, one or more than one display 28, and a variety of combinations of first memory 30 through fourth memory 36. For example, it would be possible to combine the memory into one large segmented memory. It would be possible to have the management program 22 implemented in segments on different CPU 26, connected by any number of means as will be evident to those skilled in the art with reference to this disclosure. A variety of CPU, display and memory will be satisfactory for implementation of management system 24, from a single Pentium class computer to a workstation client/server facility.

Contract Document

A suitable document checklist 38 for use in the present invention is presented in Table 1. The document checklist 38 lists one or more than one contract document 12, that will be packaged with the one or more than one rights questionnaire 10, by the packaging module 14.

By the term “contract document” it is meant to refer to either the underlying document or documents under which the intellectual property rights under consideration arise, or related documents and agreements that will be considered and examined in order to prepare the responses required and which refer or relate to the intellectual property rights under consideration. The term “contract” is used not in a limiting sense but in an exemplary sense.

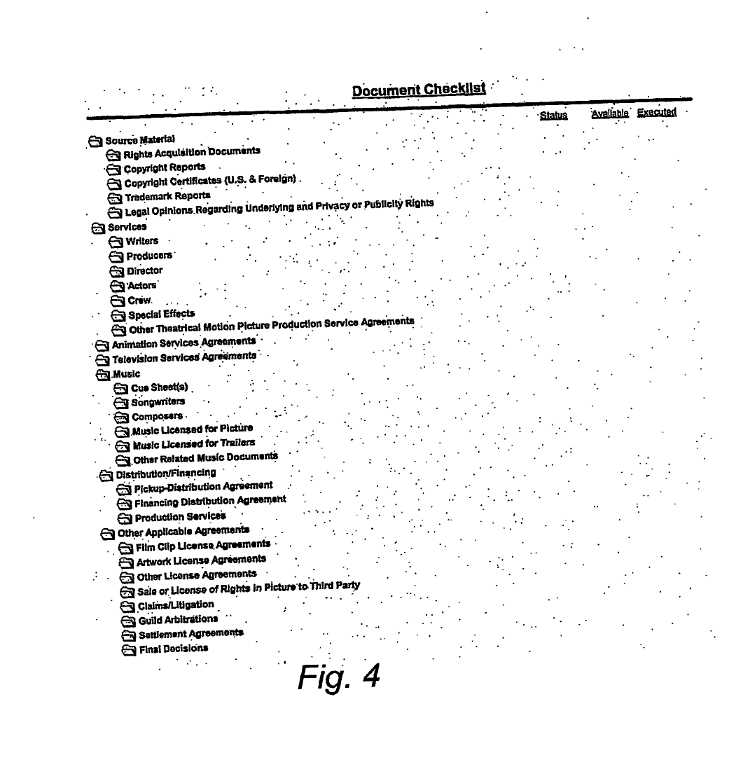

As will be evident to those skilled in the art with reference to this disclosure, variations in the order or inclusion of items in the checklist can be varied depending upon the industry involved and the type of intellectual property to be managed. Optionally, the checklist can be a simple document, an on-screen listing, an inter-active checklist, or any other embodiment that allows the user to determine whether the relevant one or more than one underlying contract document 12 has been collected or assembled. One embodiment of a document checklist 38 is shown in FIG. 4. Additionally, optionally the checklist may implemented as a directory structure, in which digital versions of the underlying one or more than one contract document 12 are stored, optionally in fourth memory 36.

TABLE 1
Source Material

Rights Acquisition Documents
Copyright Reports
Copyright Certificates (U.S. & Foreign)
Trademark Reports
Legal Opinions Regarding Underlying and Privacy or
Publicity Rights

Services

Writers

Producers

Director
Actors
Crew
Special Effects
Other Theatrical Motion Picture Production Service Agreements

Animation Services Agreements
Television Services Agreements
Music

Cue Sheet(s)
Songwriters
Composers
Music Licensed for Picture
Music Licensed for Trailers
Other Related Music Documents

Distribution/Financing

Pickup-Distribution Agreement
Financing Distribution Agreement
Production Services

Other Applicable Agreements

Film Clip License Agreements
Artwork License Agreements
Other License Agreements
Sale or License of Rights in Picture to Third Party
Claims/Litigation
Guild Arbitrations
Settlement Agreements
Final Decisions

Rights Questionnaire

The rights questionnaire 10 will vary by industry and particular intellectual property right to be managed. Thus, for example, a rights questionnaire 10 for copyright would comprise questions relevant to the various copyright laws, while a rights questionnaire 10 for patent would comprise questions relevant to the various patent laws. It is contemplated that the one or more than one rights questionnaire 10 would be created once for each management system 24, and then modified only as required by changes in law, by application of new laws, by experience with the system, or by changes in the business of the company. The flexibility of the invention would permit changes when, for example, a company expanded into foreign markets, came under new ownership, or began distributing foreign product. The rights questionnaire 10 is essentially a template of questions to be answered and legal opinions to be rendered, by a legal analyst. The term legal analyst is meant to include attorney and legal counsel, and if appropriate, paralegals.

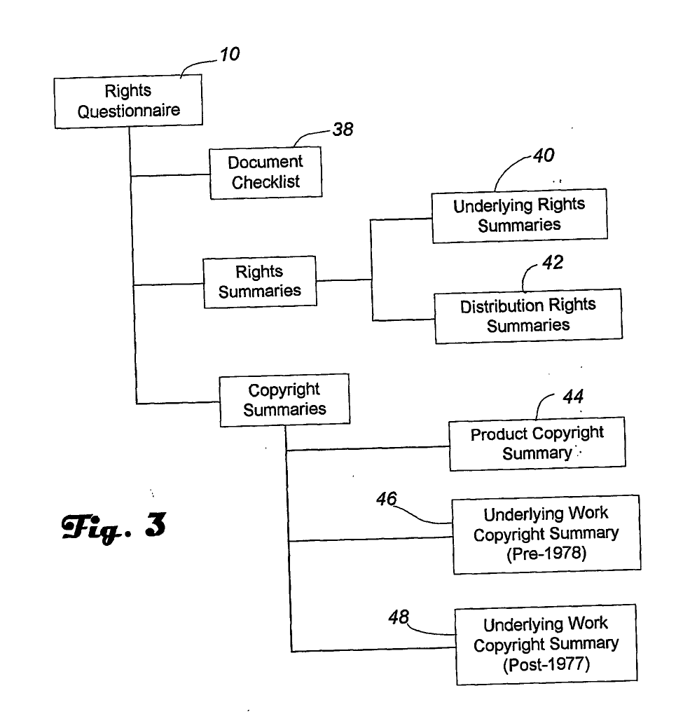

Illustration of a rights questionnaire 10 will suffice to permit those skilled in the art to modify or construct a rights questionnaire 10 satisfactory to manage according to the present invention any desired intellectual property. It is therefore not intended to limit the scope of the present invention to any specific preferred embodiment given as an exemplar. With reference to FIG. 3, in one preferred embodiment rights questionnaire 10 comprises a document checklist 38, an underlying rights summary 40, a distribution rights summary 42; a product copyright summary 44, an underlying work copyright summary (pre-1978) 46, and an underlying work copyright summary (post-1977) 48.

Thus, it can be seen that rights questionnaire 10 in other embodiments can represent a metaclass of rights reports. Further objects can be included in this metaclass, as will be evident to those skilled in the art.

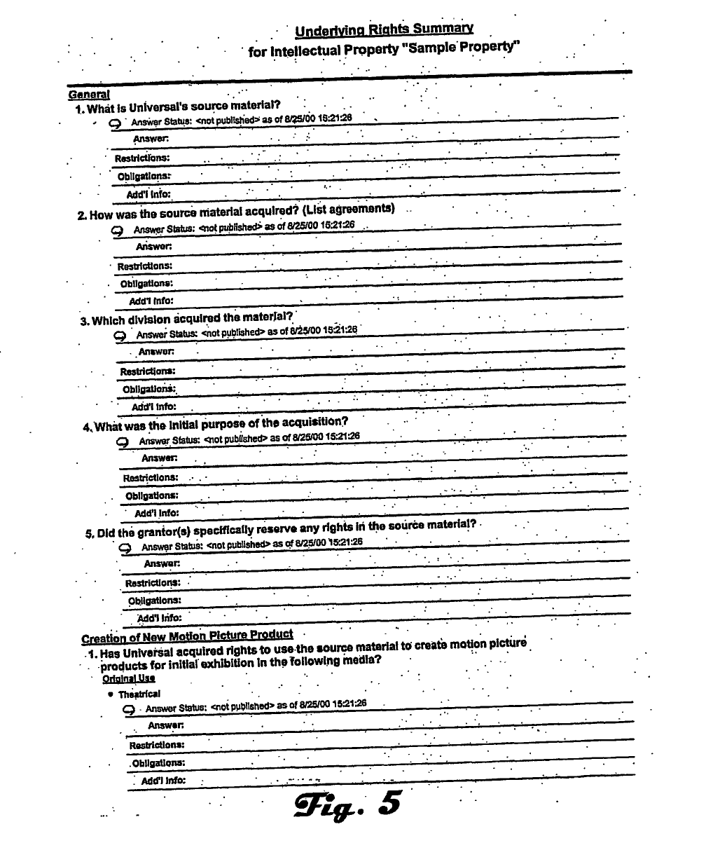

A suitable list of questions that may be included in underlying rights summary 40 are presented in Table 2. As will be evident to those skilled in the art with reference to this disclosure, variations in the order or inclusion of the questions will be possible. In one preferred embodiment, a form is created permitting direct answer of each question, listing of restrictions, listing of obligations, listing of additional information, and a field for answer status, as shown in the sample of a portion of underlying rights summary 40 in FIG. 5. In addition, an additional field may be used to facilitate entry of a legal opinion directly into the form.

TABLE 2
General

1. What is the source material?
2. How was source material acquired (List Agreements)
3. Which division acquired the material?
4. What was the initial purpose of the acquisition?
5. Did the grantors specifically reserve any rights in the
source material?

Creation of New Motion Picture Product
Has Company acquired rights to use the source material to create motion
picture products for initial exhibition in the following media?
Original Use

Theatrical
Home Video Viewing Devices (videocassette, videodisc, DVD)
Hotel Pay-per-View television
Residential Pay-per-View television
Premium Pay Cable Television
Free Television (over the air)
Basic Cable Television (satellite or cable)
Internet (entire product, linear form, for home viewing)

Subsequent Uses/Remakes

Theatrical
Home Video Viewing Devices (videocassette, videodisc, DVD)
Hotel Pay-per-View television
Residential Pay-per-View television
Premium Pay Cable Television
Free Television (over the air)
Basic Cable Television (satellite or cable)
Internet (entire product, linear form, for home viewing)

Subsequent Uses/Sequel/Prequel

Theatrical
Home Video Viewing Devices (videocassette, videodisc, DVD)
Hotel Pay-per-View television
Residential Pay-per-View television
Premium Pay Cable Television
Free Television (over the air)
Basic Cable Television (satellite or cable)
Internet (entire product, linear form, for home viewing)

Additional Uses of Source Material (new or existing product)

Soundtrack albums: Has Company acquired the right to use
the source material in soundtrack albums?
Novelization: Has Universal acquired the right to use the
source material in novelizations?
Adaptation/Rearrangement: Has Company acquired the right
to change the source material in the following ways?

Adapting or rearranging
Using in part

Live Stage: Has Company acquired the right to use the
source material in live stage productions?
Theme Park: Does the source material agreement include either a
specific grant of theme park rights, an all rights of every
kind grant, or a work-for-hire provision?
Excerpts for Advertising and Promotion:
Has Company acquired the right
to use excerpts from the source material for advertising
and promotional purposes?
Merchandising: Has Company acquired the right to use the source
material in merchandising?
Commercial Tie-Ins: Has Company acquired the
right to use the source
material in commercial tie-ins/co-promotions?

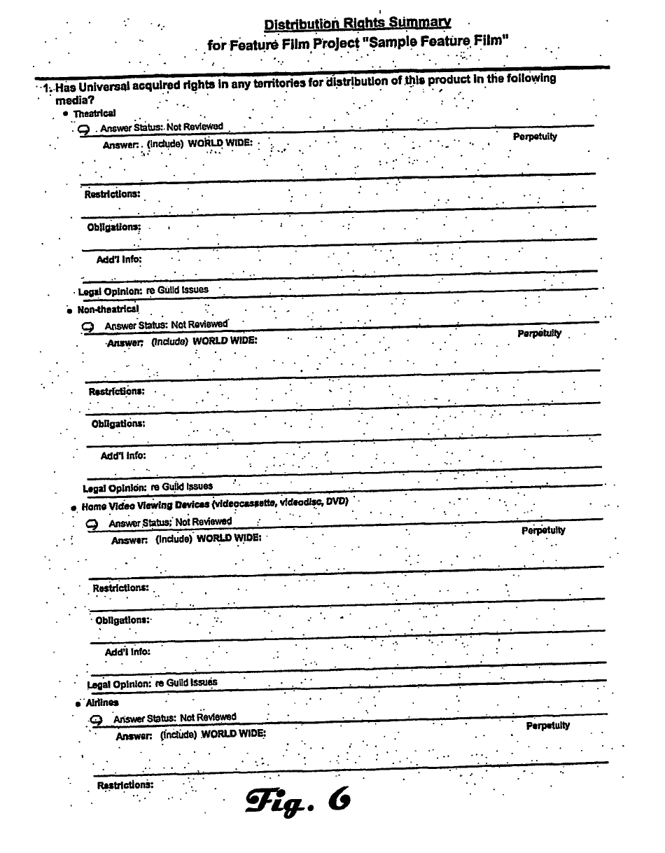

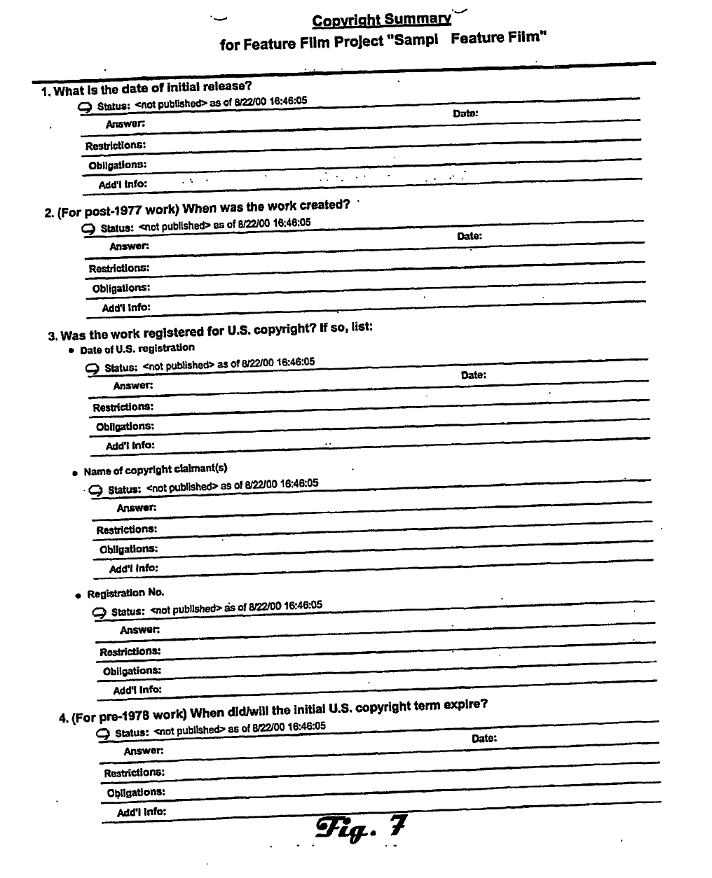

A suitable list of questions that may be included in the distribution rights summary 42 are presented in Table 3. As will be evident to those skilled in the art with reference to this disclosure, variations in the order or inclusion of the questions will be possible. In one preferred embodiment, a form is created permitting direct answer of each question, listing of restrictions, listing of obligations, listing of additional information, and a field for answer status, as shown in the sample of a portion of the distribution rights summary 42 in FIG. 6. In addition, an additional field may be used to facilitate entry of a legal opinion directly into the form. Additionally, preferably the form will include check boxes or similar indicia if the distribution rights are world wide, or in perpetuity, as shown in FIG. 6.

TABLE 3
Has Company acquired rights in any territories for distribution of
this product in the following media?

Theatrical
Non-theatrical
Home Video Viewing Devices (videocassette, videodisc, DVD)
Airlines
Hotel Pay-per-View television
Residential Pay-per-View television
Premium Pay Cable Television
Free Television (over the air)
Basic Cable Television (satellite or cable)
Internet (entire product, linear form, for home viewing)

Music: Has Company acquired rights in any territories for distribution
of the music in this product in the following media?

Theatrical
Non-theatrical
Home Video Viewing Devices (videocassette, videodisc, DVD)
Airlines
Hotel Pay-per-View television
Residential Pay-per-View television
Premium Pay Cable Television
Free Television (over the air)
Basic Cable Television (satellite or cable)
Internet (entire product, linear form, for home viewing)

Are rights to distribute to military bases or armed forces granted?
Are there any participants?
Use of Names and Likenesses in Advertising and Promotion:
Do the following agreements grant Company the right to use name,
likeness or biography to advertise and/or promote the motion picture?

Director (list name)
Producers (list names)
Author(s) of the source material (list names)
Key talent (list names)

Use of Names and Likenesses in Promotional Clips: Do the following
agreements grant Company the right to use name, likeness or biography in
clips to promote the motion picture?

Director (list name)
Producers (list names)
Author(s) of the source material (list names)
Key talent (list names)

Use of Names and Likenesses in Merchandising:
Do the following agreements grant Company the right
to use name, likeness or biography in merchandising
for the motion picture?

Director (list name)
Producers (list names)
Author(s) of the source material (list names)
Key talent (list names)

Use of Names and Likenesses in Commercial Tie-Ins/Co-Promotions:
Do the following agreements grant Company the right to use name,
likeness or biography in commercial tie-ins for the motion picture?

Director (list name)
Producers (list names)
Author(s) of the source material (list names)
Key talent (list names)

Dubbing and Subtitling: Do the following agreements include
restrictions on dubbing or subtitling the motion picture?

Director (list name)
Producers (list names)
Key talent (list names)

Editing: Do the following agreements include restrictions
on editing (cutting) the motion picture?

Director (list name)
Producers (list names)

Film to Tape Transfer: Do the following agreements include restrictions on
transferring the motion picture from film to tape?

Director (list name)
Director of Photography (list names)

A suitable list of questions that may be included in the product copyright summary 44 are presented in Table 4. As will be evident to those skilled in the art with reference to this disclosure, variations in the order or inclusion of the questions will be possible. In one preferred embodiment, a form is created permitting direct answer of each question, listing of restrictions, listing of obligations, listing of additional information, and a field for answer status, as shown in the sample of a portion of product copyright summary 44 in FIG. 7. In addition, an additional field may be used to facilitate entry of a legal opinion directly into the form.

TABLE 4
What is the date of initial release?
(For post-1977 work) When was the work created?
Was the work registered for U.S. copyright? If so, list:

Date of U.S. registration
Name of copyright claimant(s)
Registration Number

For pre-1978 work) When did/will the initial U.S. copyright term expire?
(For pre-1978 work) is renewal mandatory (copyright secured pre-1964) or
permissive (copyright secured between 1964-1977)?
(For pre-1978 work) Has the U.S. copyright been renewed? If so list:

Renewal date
Renewal claimant(s)
Renewal no.

(For all works) When did/will the U.S. copyright expire?

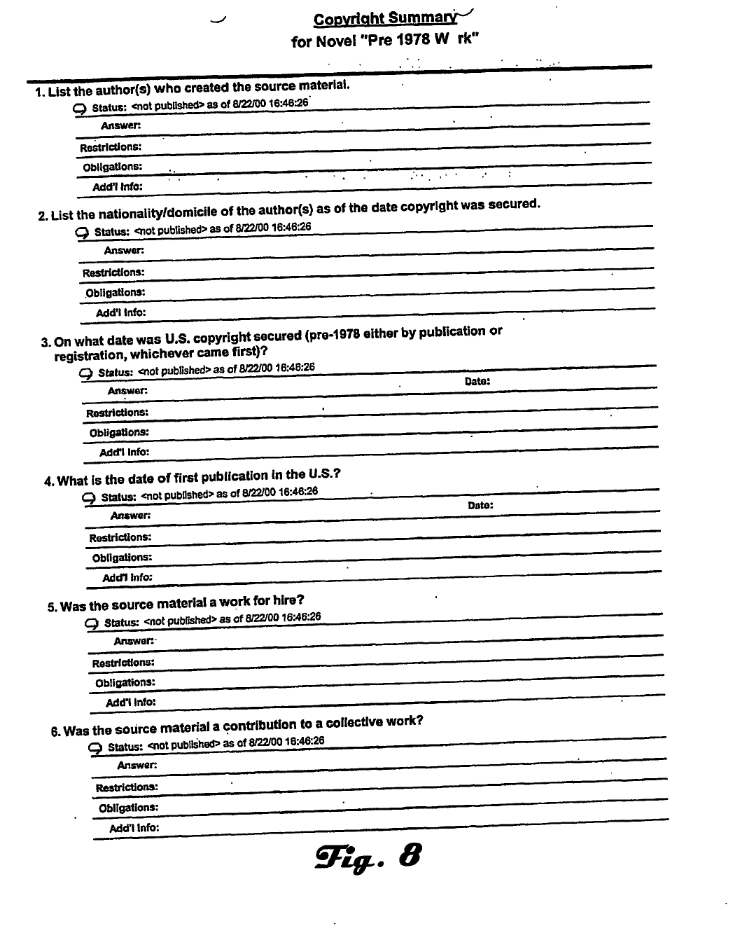

A suitable list of questions that may be included in an underlying copyright summary (pre-1978 work) 46 are presented in Table 5, and an underlying copyright summary (post-1977 work) 48 are presented in Table 6. As will be evident to those skilled in the art with reference to this disclosure, variations in the order or inclusion of the questions will be possible. In one preferred embodiment, a form is created permitting direct answer of each question, listing of restrictions, listing of obligations, listing of additional information, and a field for answer status, as shown in the sample of a portion of an underlying copyright summary (pre-1978 work) 46 in FIG. 8. In addition, an additional field may be used to facilitate entry of a legal opinion directly into the form.

TABLE 5
List the authors(s) who created the source material
List the nationality/domicile of the author(s) as of the date copyright was
secured.
On what date was U.S. copyright secured (pre-1978 either by
publication or registration, whichever came first)?
What is the date of first publication in the U.S.?
Was the source material a work for hire?
Was the source material a contribution to a collective work?
Was the source material registered for U.S. copyright? If so:

List date of U.S. copyright registration
List copyright claimant(s)
List Registration No.
State whether the work was registered as a published or unpublished
work

When did/will the initial copyright term expire?
Was Company (or its predecessor in interest) granted rights by the
author(s) in the renewal term?
Is renewal mandatory (copyright secured pre-1964) or permissive
(copyright secured between 1964-1977)?
Has the U.S. copyright been renewed? If so, list:

Renewal date
Renewal claimants
Renewal no.
If renewed, either automatically or through registration, when did/will
the U.S. copyright expire?

If any author(s) are deceased, list author(s) and date(s) of death.
Is the source material (if not-for-hire work) potentially affected by
the Abend decision?
List all agreements with the statutory beneficiaries of the authors for the
renewal period. Pleas include the date and the parties.
Are Company's rights in the source material potentially terminable
in the U.S. under Section 203 or 304 of the U.S Copyright Act?
Has notice of termination been served under Section 203 or
Section 304 of the U.S Copyright Act?
What is/are the earliest date(s) upon which such terminations(s) could take
effect?

TABLE 6
List the authors(s) who created the source material
List the nationality/domicile of the author(s) as of the date copyright was
secured.
On what date was U.S. copyright secured (pre-1978 either by publication
or registration, whichever came first)?
What is the date of first publication in the U.S.?
Was the source material a work for hire?
Was the source material a contribution to a collective work?
Was the source material registered for U.S. copyright? If so:

List date of U.S. copyright registration
List copyright claimant(s)
List Registration No.
State whether the work was registered as a published or unpublished
work

When did/will the copyright term expire?
Are Company's rights in the source material potentially terminable in
the U.S. under Section 203 of the U.S Copyright Act?
Has notice of termination been served under Section 203 of the U.S
Copyright Act?
What is/are the earliest date(s) upon which such terminations(s) could take
effect?

Packaging Module

The packaging module 14 facilitates the collection of the one or more than one contract document 12 and one or more than one rights questionnaire 10 that will be used to review the intellectual property rights under consideration, and packages these documents for transmission to the appropriate reviewer.

Referring to FIG. 1 and FIG. 2, packaging module 14 is part of management program 22, and in a preferred embodiment can be stored in first memory for program storage 30. It will be possible, however, to have packaging module 14 stored on a different CPU 26 than the remainder of management program 22, or on different servers within a network of computers.

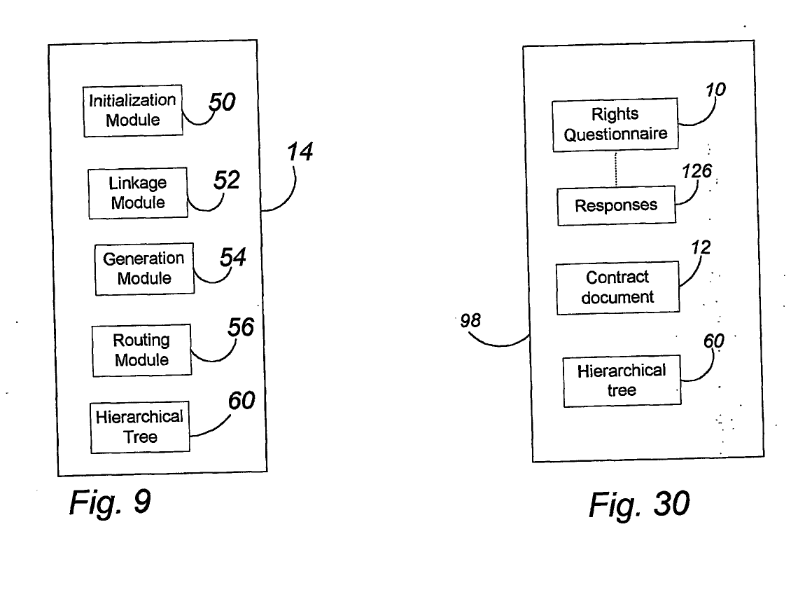

In one embodiment as shown in FIG. 9, packaging module 14 comprises an initialization module 50 to initialize the program and create necessary records, a linkage module 52 to link the data to existing properties, projects, actors, talent, and similar entries, a generation module 54 to generate the rights questionnaire 10 appropriate for the circumstance, and a routing module 56 to send the generated rights questionnaire 10 to the review module 16.

The packaging module 14 will be operated by an individual who may be referred to as the packager (not shown) to emphasize that the individual who operates the packaging module 14 may be different from the person or persons who operate the remaining modules. In one embodiment, a packager operates the packaging module, a reviewer operates the reviewing module and a searcher operates the search module. In another embodiment, the packager and searcher are the same person. In one embodiment the reviewer is an attorney within in a corporate legal department. In another embodiment, the reviewer is an attorney in an outside law firm.

Initialization Module

The process as described herein for the operation of the initialization module 50 proceeds with respect to a completed product. As is apparent to those skilled in the art with reference to this disclosure, the system is readily adapted and useable for a new product. Thus, as each agreement on a new project is completed, the system is useable in accordance with the present invention by completing the questions relating to that agreement. Further, constraints upon entry (e.g., an agreement might not be entered until it is executed) can be used to act as a check in such instance.

In a preferred embodiment of an initialization module 50 a program is written in a windows based environment that permits a user to choose among menu options. Programming languages adequate to accomplish this are well known.

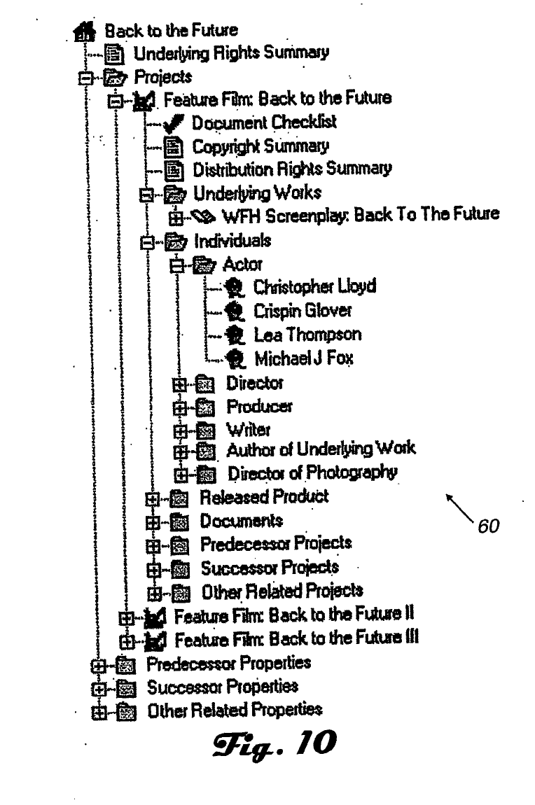

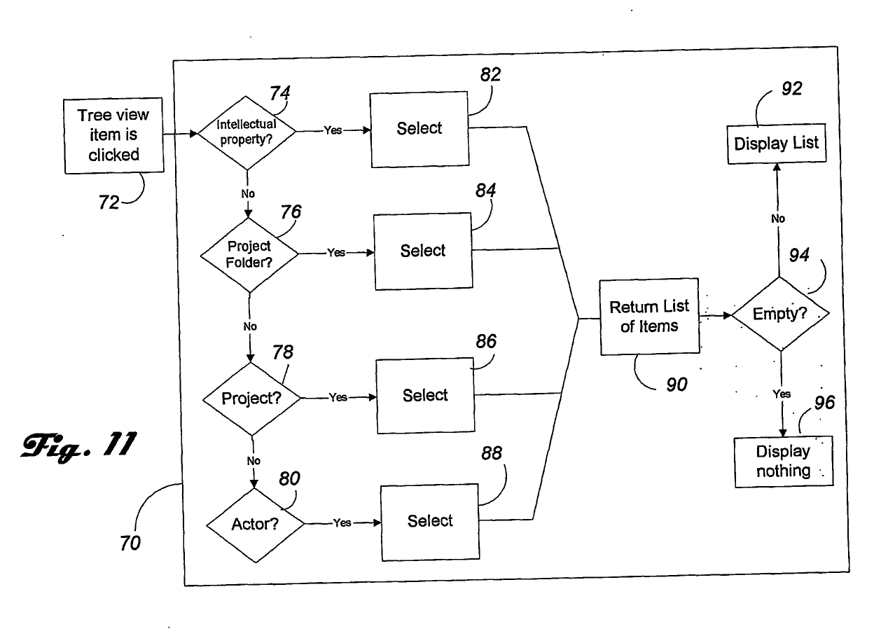

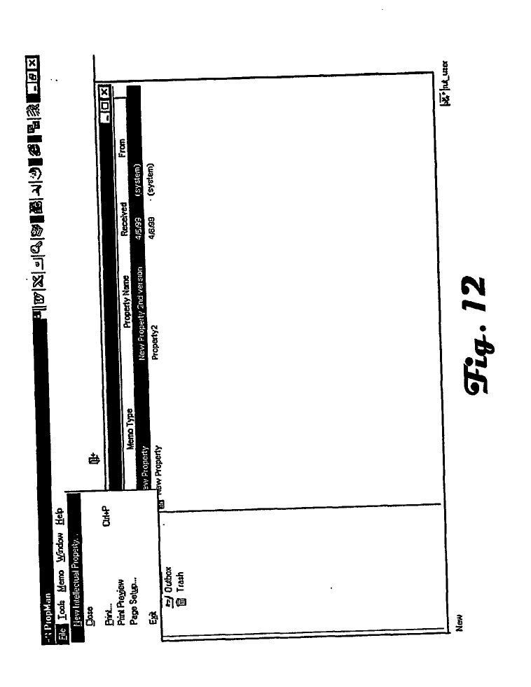

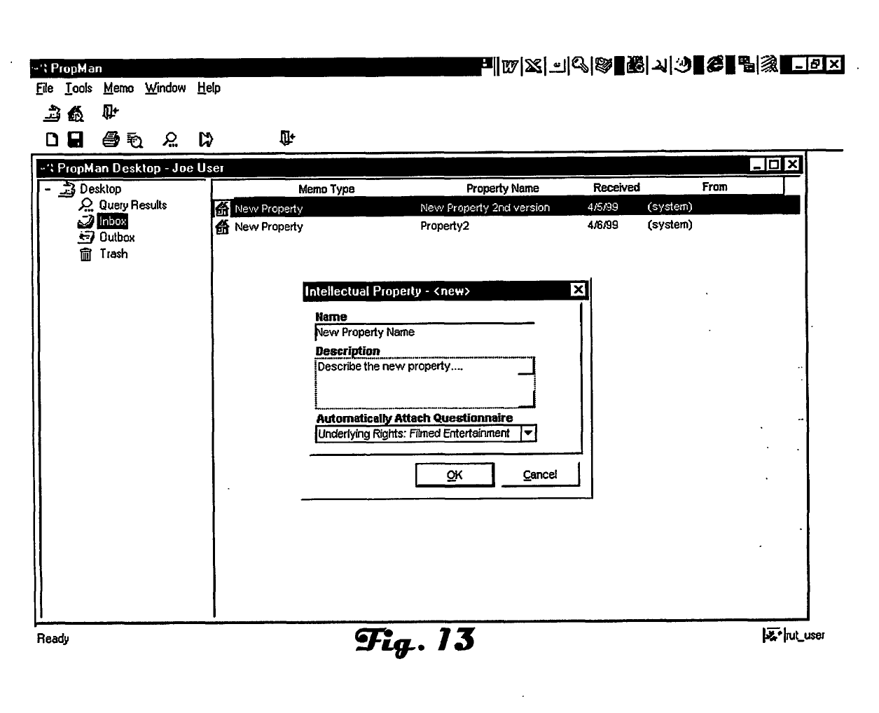

The initialization module 50 presents the packager with the option of choosing “New Intellectual Property” from a menu selection, at which point a New Intellectual Property window or dialog box comes up to allow entering of information about the property. This can include the name of the property, a substitute name, and a description of any notes about the property-product-copyright family. Upon saving or closing the window or dialog box a record is created in a database and the newly entered property is displayed in the desktop in a hierarchical tree structure. Screen shots showing operation of these selections are shown in FIG. 12 and FIG. 13.

Hierarchical Data Structure

With reference to FIG. 10, an example is shown where the new intellectual property is a motion picture titled “Back to the Future” and appears at the head of hierarchical tree 60. Each row is called an “Item” and the indentation of the Item is its “Level”. The Item “Back to the Future” is at “Level 1,” while the “Feature Film: Back to the Future” is at “Level 3.” This tree displays the intellectual property hierarchy.

With reference to FIG. 11, hierarchical tree 60 may be constructed by calling a stored procedure 70 and passing the current Item type and the current Item's identifier. Stored procedure 70 is stored within first memory for program storage 30. The stored procedure 70 returns a list of items. When Item “Feature Film: Back to the Future” is expanded for the first time, the stored procedure is called with Item type “Level 3,” and item identifier 131. The stored procedure then through a series of database queries assembles the item list containing all of the documents attached to the project and the list of folders contained by the project, as shown in FIG. 10.

A flowchart for the tree creation process for creating hierarchical tree 60 is shown in FIG. 11. When a user clicks 72 a tree view item, program control gets the item type and ID and calls a stored procedure 70. Within the stored procedure 70, the first test is whether the item type is an intellectual property 74, and if so, the stored procedure 70 selects 82 a list of document items from a database and combines list with a list of folders. If not, the next test is whether the item type is a project folder 76, and if so, the procedure selects 84 a list of projects attached to the intellectual property. If not, the next test is whether the item type is a project 78, and if so, the procedure selects 86 a list of documents items from a database and combines with a list of folders. The next test is whether the item type is an actor 80, and if so, the procedure selects 88 a list of actors attached to the project. In like fashion, other sub-level items can be tested, and selection made accordingly.

After selection, the procedure 70 returns 90 a list of items to hierarchical tree 60, and tests 94 whether the list is empty. If so, nothing is displayed 96 and the clicked item is marked as expanded so that the procedure will not be called again. If not, the list of items are displayed 92 as children of the clicked item.

By associating sets of information as described the packager and other users have available a hierarchical tree 60. By treating these sets of information as objects that attach to classes, and in turn to metaclasses, a data structure is created that makes it possible to easily view the relationship between objects. With reference to FIG. 10, a screen such as shown might be viewed by a user, who would be able to determine that Christopher Lloyd, Crispin Glover, Lea Thompson and Michael J. Fox (objects) are associated to Actors (class) which in turn is associated to Individuals (metaclass) which is associated to a particular feature film. Therefore, information relating to an object (e.g., a particular actor) can be linked to multiple projects for a particular product, or even to multiple products. By linking through the tree view, a central point is provided through which the system user can find relationships that might otherwise not be evident.

The relationship between objects and classes is facilitated in the view illustrated in FIG. 11, by mixing object data with higher level classes. Space on the packager's and other user's screen is also saved by this arrangement.

Generation Module

The generation module 54 functions to generate and optionally attach to the database the one or more than one rights questionnaire 10. In one preferred embodiment, the set of one or more than one rights questionnaire 10 prepared as described above is automatically generated and attached to the hierarchical tree structure when the initialization module creates the records for the new intellectual property.

Optionally, a generation module 54 could offer the packager a choice of rights questionnaire 10, for example relating to patent rights if the new intellectual property is a patent, or copyrights if the new intellectual property is a movie.

In a preferred embodiment as shown in FIG. 10, underlying rights summary 40 is retrieved from second memory for questionnaire storage 32 and attached to the hierarchical tree 60 at the time that the new intellectual property is created. As will be apparent from examination of FIG. 10, only the underlying rights summary 40 can be attached at this point, since no project has been associated with the property.

As individual projects are attached to the hierarchical tree 60, the generation module 54 may be repeatedly used to generate and attach further rights questionnaire 10 as appropriate. As shown in FIG. 10, this could include document checklist 38, distribution rights summary 42, and product copyright summary 44.

In a preferred embodiment, the generation module 54 operates when the packager switches the desktop to a hierarchical view showing the hierarchical tree 60, clicks on a plus sign next to the Projects folder item under the root item (which is the new intellectual property), right clicks on the Project in question, revealing a popup menu. A window or dialog box with a list of one or more than one rights questionnaire 10 will appear, which may be selected. This may be repeated if other projects have been added to the hierarchical tree 60.

Linkage Module

The linkage module 52 functions to link the data to existing properties, projects, actors, talent, and similar entries, in a process that will be well known to those skilled in the art with reference to this disclosure.

Operation of Packaging Module

Having described the components of the packaging module, I now describe the process using that module. The packager requests the appropriate physical files relating to the film project. This might include by way of example, contracts, distribution agreements, assignments, and the like. Preferably, copies are made of these documents, so that they may be forwarded to the one or more individuals who will review the documents in accord with the present invention. Additionally, optionally the documents could be assembled in electronic format, as will be evident to those skilled in the art with reference to this disclosure.

When the packager is satisfied that there is sufficient information to begin the creation of the intellectual property and project, the process proceeds to initialization.

Initialization Step

With reference to FIG. 12, an intellectual property is entered into the system by selecting, from a menu, “File+New Intellectual Property . . . ” which brings up the New Intellectual property window to allow entry of information about the property. As shown in FIG. 13, the New Intellectual Property window, titled “Intellectual Property—<new>” permits entry of name of property, which may be a substitute name for the property, for example the tide of proposed motion picture, a description containing notes about the property-product-copyright family.

As shown in FIG. 13, preferably provision is made at this point to automatically attach one or more rights questionnaire 10, preferably an underlying rights summary 40. In this way, whenever a property is created, a rights questionnaire 10 directed to the underlying rights in that property becomes associated with the property and is automatically linked.

Once the OK button is clicked the data entered in the New Intellectual Property window is saved and the window closes. The newly entered property can now be displayed on the desktop, and as shown will appear in the hierarchical tree 60.

Create New Project Linking

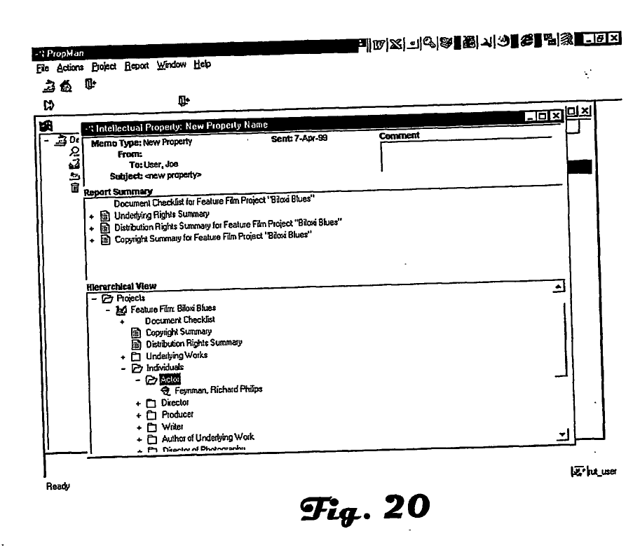

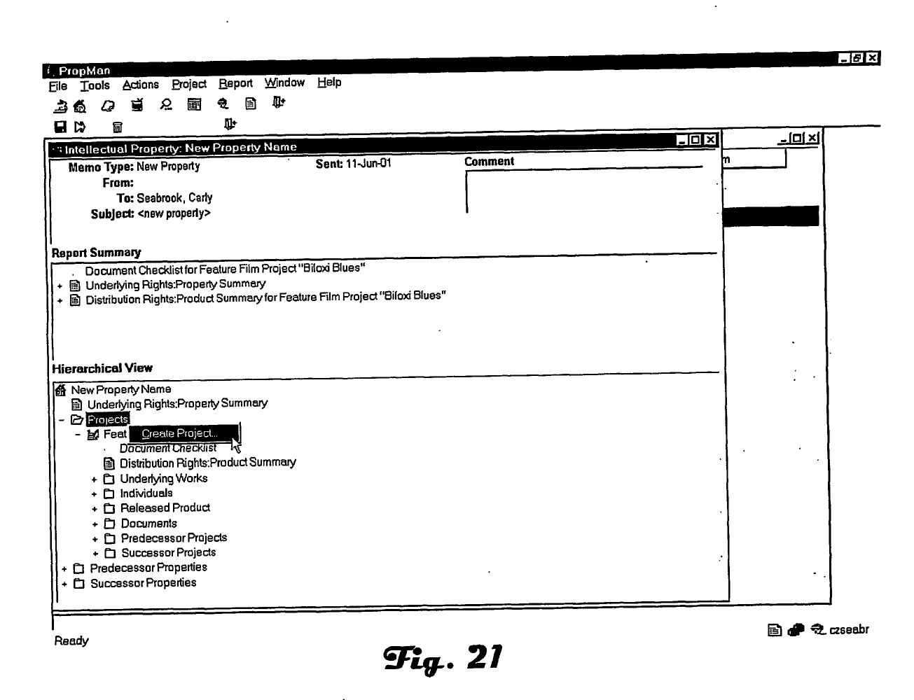

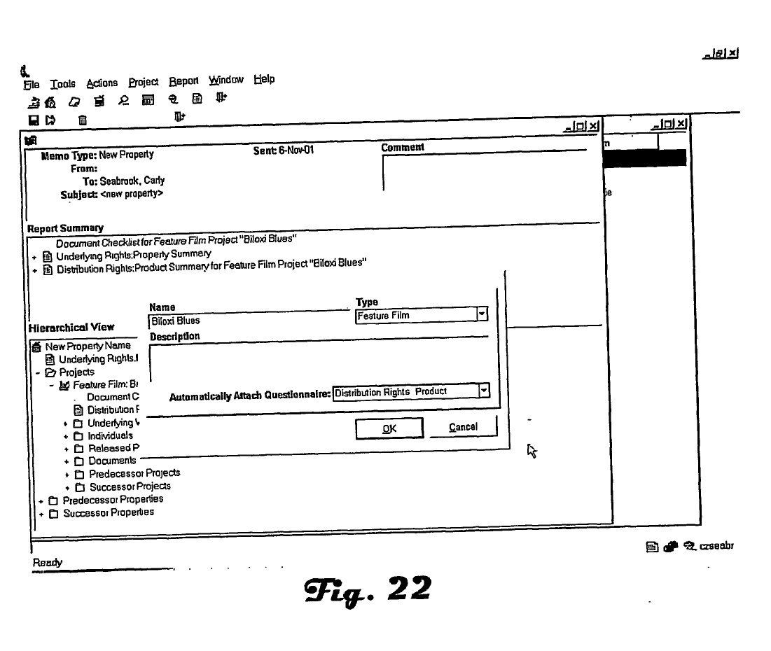

Once a new intellectual property is created, a specific new project is linked to the intellectual property. In other embodiments, it is also possible to create a project placeholder which is later edited. Selecting the intellectual property by double-clicking or other appropriate selection means, and preferably entering a hierarchical view using hierarchical tree 60, right click on the Projects folder item shown in FIG. 22 and select an appropriate item from a first menu as shown in FIG. 21, which invokes an entry window titled “Project—<new>” as shown in FIG. 22. Enter the name, media type and description information if needed, and then attach a rights questionnaire 10. As shown in FIG. 22, a distribution rights summary 42 is automatically attached to a created product/project. Clicking the OK button saves the entered data into third memory for response storage 34, and the information will now appear in the hierarchical tree 60.

If and when the project title changes one needs to use a tools section drop-down dialogue box (not shown) and edit the product name and other information as needed. Creation of editing techniques within database programs is well known in the art.

It is also possible to save an existing underlying rights summary 40 in the instance of a sequel or remake, which would be linked at the “project” level.

Document List

Preferably, document checklist 38, the rights questionnaire 10 that functions as a checklist for the one or more than contract document 12 that is needed to respond to the one or more than one rights questionnaire 10, is automatically retrieved from second memory for questionnaire store 32 and attached to the hierarchical tree 60 once a project is attached. Multiple document checklist 38 can be attached as more project/products are attached to an intellectual property, and preferably these will be shown at a level in the hierarchical tree below the project/product. As example showing the presence of document checklist 38 in the hierarchical tree 60 can be seen in FIG. 20. Also, as shown in FIG. 20, a summary view window can be created which lists all rights questionnaire 10 which have been attached to the property.

Although it is possible to construct document checklist 38 with a static list of document categories without means for listing one or more than one contract document 12 in each category, preferably provision is made to allow editing of document checklist 38 to show such association. In one embodiment, initialing the editing process for document checklist 38 invokes a window as shown in FIG. 27. Clicking on the category menu displays potential document categories as shown in FIG. 28. It is then possible to enter a date, description, and status for one or more than one contract document 12 in each category. As shown, it is also possible to enter information as to whether the contract document 12 is available or executed.

In a further embodiment, attaching a specific contract document 12 at document checklist 38 will associate a digital copy of that contract document 12 residing in fourth memory 36. This can be done by various relational database means, as will be evident to those skilled in the art with reference to this disclosure. For example, contract document 12 may have been digitally scanned after execution using a flat bed scanner, saved as an image file in tagged image format (TIF) or in a document interchange format such as portable document format (PDF), and stored in fourth memory 36. Alternatively, contract document 12 may simply be a hard copy paper document, to which reference must be made upon examining document checklist 38.

Link Existing Product to Project

For any given intellectual property, one or more than one “project” may be undertaken to create a “product.” Thus, for any given project on a given intellectual property, there may be one or more than one pre-existing products released into distribution from completed projects, and, one or more than one other projects that precede, succeed, or are otherwise related to the instant project. Using the hierarchical tree 60 of the present invention allows the easy coordination of all such related product, predecessor projects, successor projects, and other related projects.

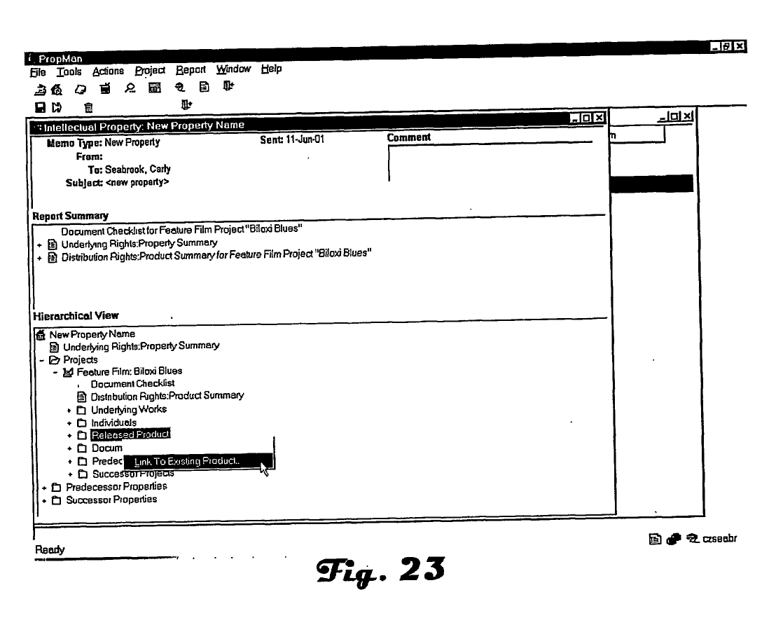

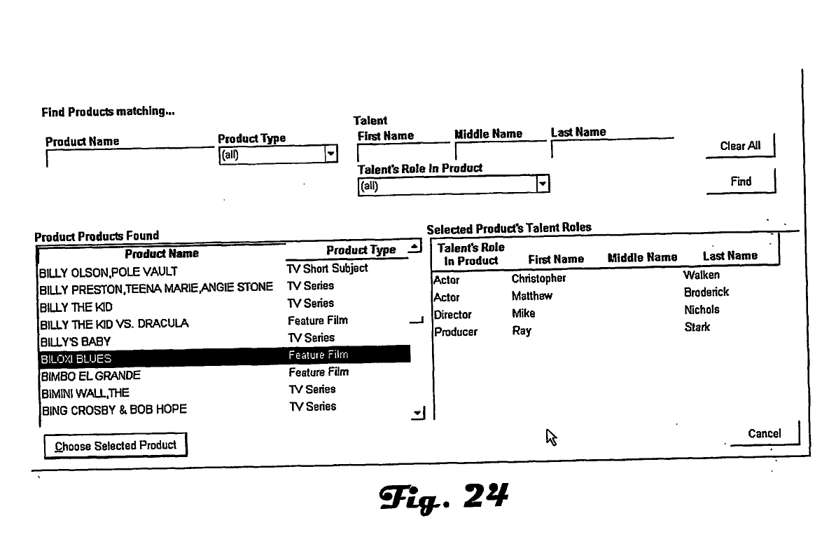

With reference to FIG. 23, a click on “Released Project” (or Predecessor Projects, Successor Projects, and Other Related Projects as the case may be), brings a drop down box from which “Link to Existing Product” may be chosen. With reference to FIG. 24, this will display a window showing a list of released product, preferably including all titles in the library of the company's released product, in this case motion picture films. Preferably, a search function as will be evident to those skilled in the art with reference to this disclosure, is incorporated into the window as shown in FIG. 24 to assist in searching if the library is extensive.

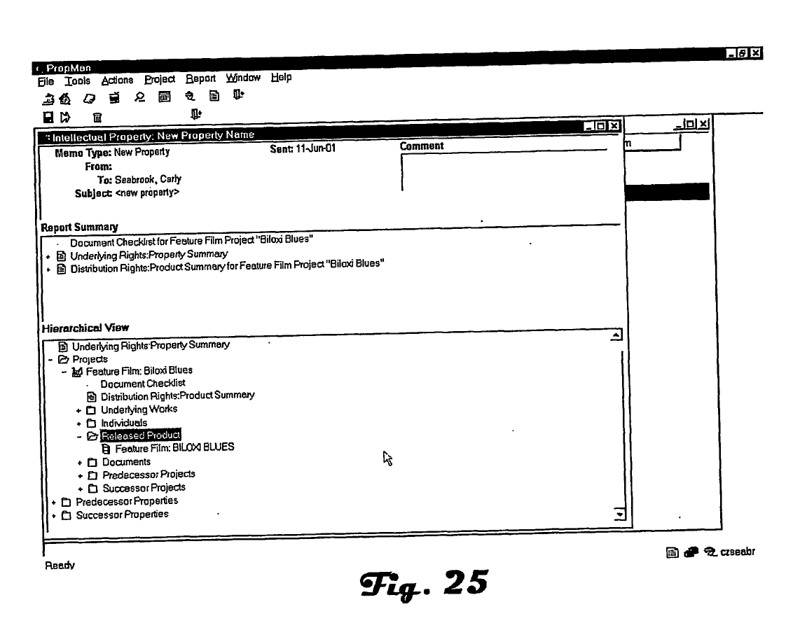

Upon finding the appropriate released product (or predecessor project, successor project, or other related project as the case may be), selecting the product (or project) will attach the item under the appropriate heading in hierarchical tree 60 as shown in. FIG. 25 and dose the search box. Optionally, if a record for that product (or project) is stored in third memory 34, a link may be established to such data, and to any corresponding contract document 12 stored in fourth memory 36. Clicking on the linked product could then open the hierarchical tree 60 saved for that project in third memory 34. As will be evident to those skilled in the art with reference to this disclosure, using relational database techniques, the hierarchical tree 60 makes it possible to cross index the instant project with the responses to any rights questionnaire 10 stored in third memory 34 (or contract document 12 stored in fourth memory 35) for such other released product, predecessor project, successor project, or other related project. Therefore, use of the invention over tine will result in more links between product and projects, and corresponding better retrieval of related information.

Attach Product Copyright Summary

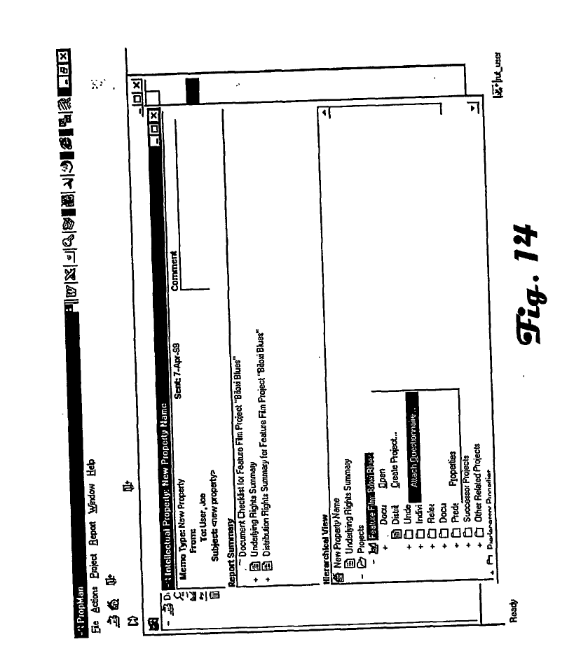

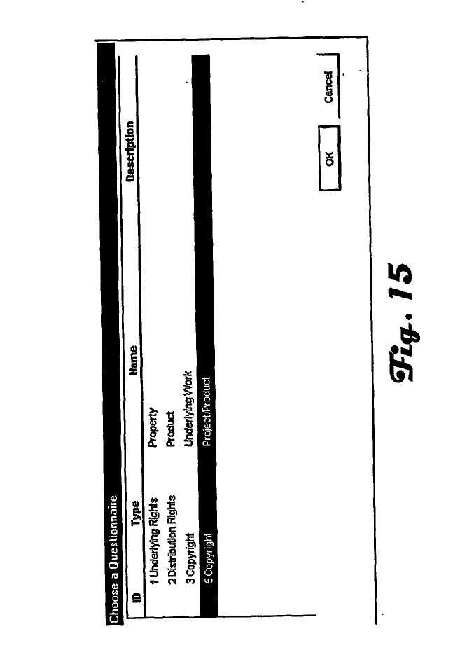

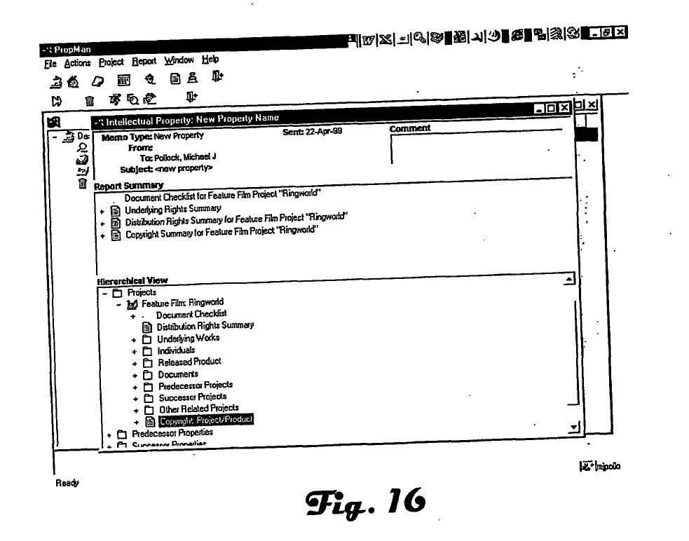

After a specific project is created and linked to the intellectual property using the hierarchical tree 60, product copyright summary 44 may be linked to the project in a manner shown in FIG. 14 through FIG. 16. With reference first to FIG. 14, and using the hierarchical tree 60, a click on the project in question invokes a pull down menu as shown in FIG. 14. Selecting “Attach Questionnaire” invokes a list window as shown in FIG. 15, listing available rights questionnaire 10 that can be attached to the project. In this instance, highlighting “Copyright Project/Produce” and clicking “OK” causes the product copyright summary 44 stored in second memory 32 to now be associated with and attached to the instant project, as shown in the hierarchical tree 60 in FIG. 16. In like manner, any rights questionnaire 10 can be attached to projects, or if desired to a released product, a predecessor project, a successor project, or other related projects.

Optionally, preferably distribution rights summary 42 is automatically attached when the project is created. If that is not done, then the distribution rights summary 42 may be attached to the project as described.

Attach Talent

As shown in hierarchical tree 60 in FIG. 17, it is possible to use the invention to attach a plurality of individuals, known as “talent,” including actors, producers, writers, authors of underlying work, directors, and the like, to a particular project. Using relational database techniques, this also makes it possible to determine for any given actor, etc., to which projects an attachment has been made.

A preferred embodiment of hierarchical tree 60 uses a folder content metaphor displaying both folders and contents in the same tree. As shown in FIG. 20, once an attachment to hierarchical tree 60 has been made, the attached actors display with name and appropriate icon. Optionally, by clicking on a particular attached individual, a list may be displayed (not shown) identifying the projects and products to which that individual has been attached. In a further embodiment (not shown), other information about the individual could be stored in third memory 34 and displayed upon request.

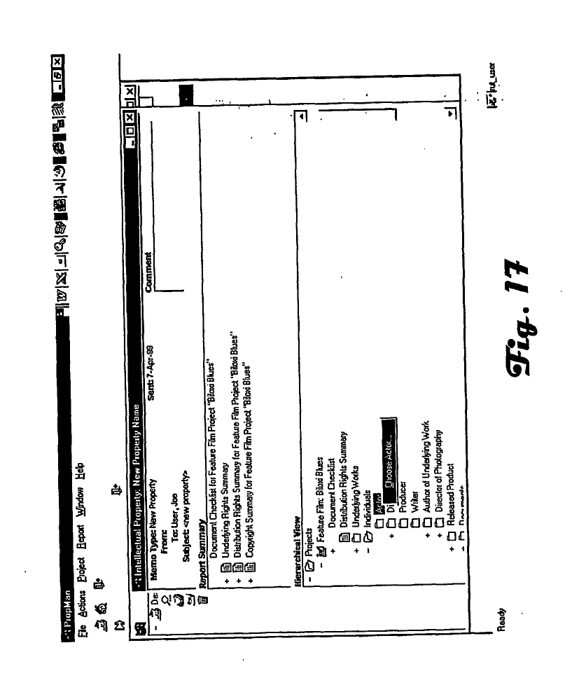

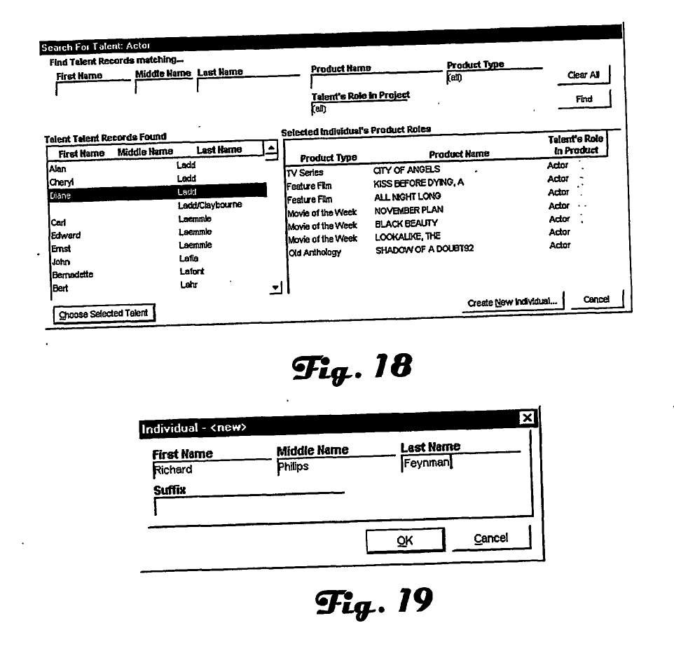

Clicking on the folder “Actors” as shown in FIG. 17 displays a pull-down menu from which “Choose Actor” may be selected. The menu may be context sensitive, so that it will display “Choose Director” is for example the click was over the “Director” folder. As shown in FIG. 18, a window then displays a list of actors who have previously been linked to products or projects, or otherwise added to storage in third memory 34. Preferably, a search function as will be evident to those skilled in the art with reference to this disclosure, is incorporated into the window as shown in FIG. 18 to assist in searching if the actor list is extensive. Optionally, preferably provision is made for adding new individuals, using a dialog box as shown in FIG. 19. Additionally, optionally a list of all existing links may be displayed when an individuals name is selected, as shown in FIG. 18.

Upon finding the appropriate individual actor (or director, producer, writer, author, or other individual as the case may be), selecting the individual will attach the name and a face icon under the appropriate heading in hierarchical tree 60 as shown in FIG. 20 and close the search box.

Sending to Reviewing Counsel

With reference to FIG. 30, the process as described now has created an intellectual property package 98 comprising one or more than one rights questionnaire 10, one or more than one contract document 12, and a hierarchical tree 60, but not at this point responses 126. In the case of the described embodiment, one or more of document checklist 38, underlying rights summary 40, distribution rights summary 42, product copyright summary 44, underlying work copyright summary (pre-1978) 46, or underlying work copyright summary (post-1977) 48 may be attached, as well as one or more individuals.

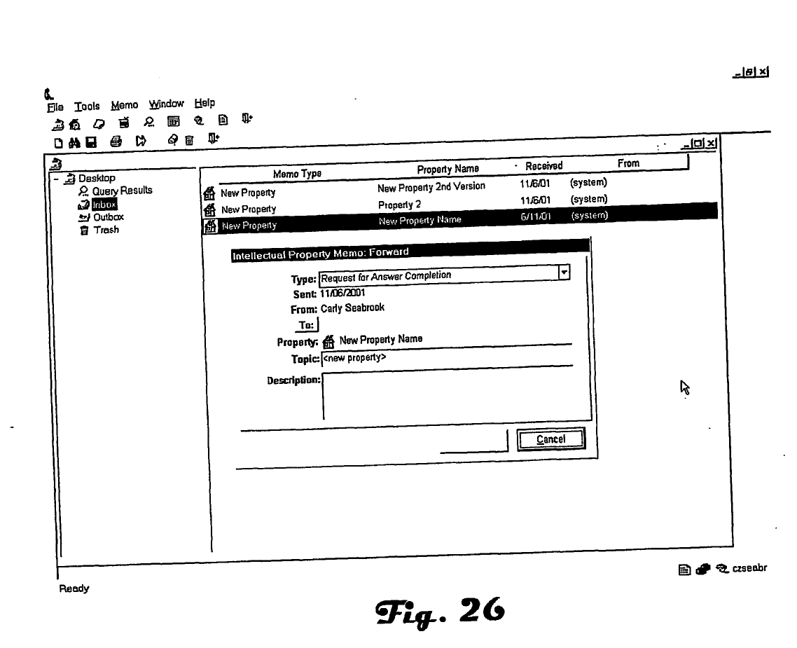

In one embodiment, as shown in FIG. 26, clicking on the intellectual property on the desktop and making an appropriate selection invokes a mail routine which displays a window allowing specification of the recipient of the property, with fields for topic, and descriptions. Clicking “Send” then transmits intellectual property package 98 to the recipient.

As will be evident to those skilled in the art with reference to this disclosure, transmission of intellectual property package 98 may be done in a variety of ways. In one embodiment, in which the recipient is a user of a local area network which gives access to third memory 34 and fourth memory 36, it may be sufficient for the transmission to simply be an e-mail message informing the recipient that the intellectual property has been packaged and is ready for review. This may be the case, for example, where the recipient is a member of the corporate legal staff.

In another embodiment, the recipient does not have direct access to third memory 34 or fourth memory 36. This might be the case, for example, with an outside law firm. In that event, routing module 56 should contain provision to print out the components of intellectual property package 98, being each of the one or more attached rights questionnaire 10, one or more than one contract document 12, and hierarchical tree 60. The documents comprising intellectual property package 98 are then delivered physically to the recipient.

In a further embodiment, the recipient does not have direct access to third memory 34 or fourth memory 36, but does have access to secure electronic mail through the Internet. The routing module then assembles the one or more attached rights questionnaire 10, one or more than one contract document 12, and hierarchical tree 60 into intellectual property package 98, compresses the package if desired using available compression techniques, encrypts the package if desired using available encryption techniques, and transmits the package to the recipient. Packaging and unpacking engines for transmitting and receiving packages of compressed and encrypted documents as known in the art.

Review Module

Referring now to FIG. 1, control in management program 22 now passes to the review module 16. In one embodiment, program code for review module 16 is stored in first memory 30 and runs on CPU 26. This would be a typical embodiment for in-house counsel review in a corporate legal department.

In a preferred embodiment, review module 16 is processed at an outside law firm that has been retained to provide responses to the questions posed in the one or more than one rights questionnaire 10, with a combination of electronic and physical communication to CPU 26. An appropriate review module will be implemented at an outside law firm in a manner similar to FIG. 2, having at their remote location a CPU 26, a display 28, first memory 30 for storage of the program code for the review module 16, third memory 34 for storage of the packaged rights questionnaire 10 and hierarchical tree 60 received from the company, and fourth memory 36 for storage of any contract document 12 received in electronic form. If any applicable rights questionnaire has been attached to the package and transmitted to the law firm by packaging module 14, a second memory 32 is not needed. Optionally, the packaging program may reference a standard rights questionnaire rather than actually transmit a copy. In such an embodiment second memory 32 would be needed at the law firm site to store the various rights questionnaire 10 that are used, and hierarchical tree 60 may then be used to link. In such an embodiment it will be necessary to implement some additional version control procedure to be sure that changes in rights questionnaire 10 are communicated to the law firm. The CPU 26 necessary to operate the review module at a law firm can be of the standard PC variety well know to the art.

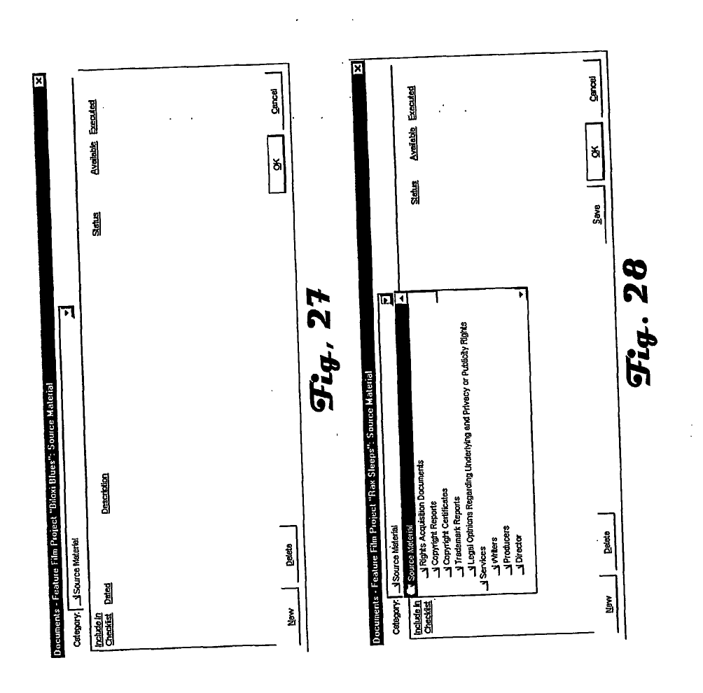

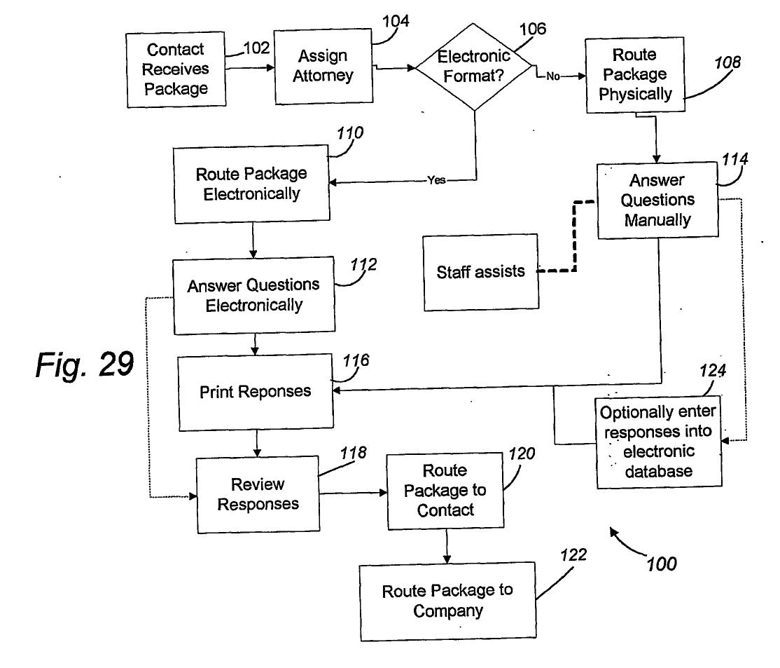

In an embodiment using an outside law firm, with reference to FIG. 29, the review process 100 followed at the law firm begins at step 102 where one of the described embodiments of intellectual property package 98 is received, electronically or physically, or both, at the chosen law firm, and it is routed to a contact point chosen to receive the package and act upon it. This will typically be an outside law firm, or persons chosen within the organization such as lawyers in a legal department. As will be evident to those skilled in the art with reference to this disclosure, the process of the review module is adaptable to either situation. The determining criteria would be that the contact person, and appointed personnel, be qualified to answer the questions presented.

In step 102 the contact person receives the intellectual property package 98 and either personally or through an assistant unpacks, un-encrypts, and un-compresses intellectual property package 98, as needed. In step 104 the contact assigns a reviewer comprising an attorney or a group of attorneys, or paralegal assistant if appropriate, to address the one or more than one rights questionnaire 10 contained in such package.

As will be seen by reference to the questions in Tables 1 through 6, questions which do not require a legal opinion could be answered by paralegal professionals, while those requiring rendering of legal opinions would be reserved for answering by legal counsel.

In step 106 it must be determined which components, if any, of intellectual property package 98 are available in electronic format. This may be done by an assigned attorney, paralegal, or secretarial staff. If the components are not in the system, and are only available in hard copy format, the process proceeds to step 108 where the components of intellectual property package 98 are physically transferred to the reviewer. Alternatively, if one or more components of intellectual property package 98 are available in electronic format, the process proceeds to step 110 where the components available in electronic format are sent electronically to the reviewer using e-mail or other available delivery, and the balance transferred physically if necessary.

If the attorney has the reports available electronically, as on a personal computer, the individual questions may be addressed electronically directly through a computer interface into a database format or a word processing format. For example, the reports might be available as Word or WordPerfect documents, and stored on a network in a designated folder. The analyst can be alerted to the existence of the reports and their full path and filenames, and an appropriate word processing system could be used, as is well known in the art, to open the reports and proceed to address the individual questions. The file containing the answered questions would then be saved.

Templates and tables are easily constructed with most popular word processing systems that allow for entry of information, and would be readily adapted for this system.

Alternatively, the reports could be made part of a database system and a database program, for example on a personal computer using an Intel Pentium processor, could be used to examine the reports. Thus, a database could be maintained for each report, having a data structure of one record per question, and fields comprising the question, the answer, the answer status, the restrictions, the obligations, additional information, and legal opinions. Alternatively, the question could be comprised of further sub-parts, with data structure including an object field with entries such as “director,” “producer” and “talent.”

After the file is routed electronically to the assigned reviewer in step 110 or physically in step 108, the process proceeds to either step 112 where the attorney electronically answers the questions in the rights questionnaires, or step 114 where the reviewer answers the questions manually, using a staff assistant to type the answers if needed.

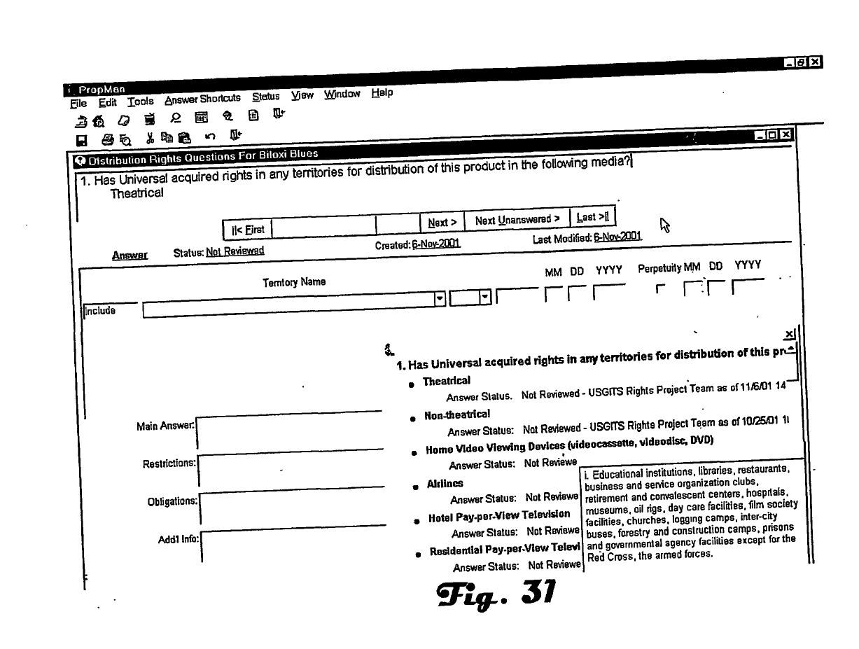

A screen shot of an exemplar window to facilitate answering distribution rights 42 is show in FIG. 31. The embodiment shown incorporates an answer hints box, which may assist the reviewer in drafting an appropriate answer to the questions. This may be made context sensitive, changing the answer hints for each question. The answer hints may be saved in a relational database that is store within second memory 32.

In a typical embodiment, the reviewer will select questions in a window that need to be answered, with navigation between questions as will be evident to those skilled in the art with reference to this disclosure. A tally of questions answered and to be answered may be provided.

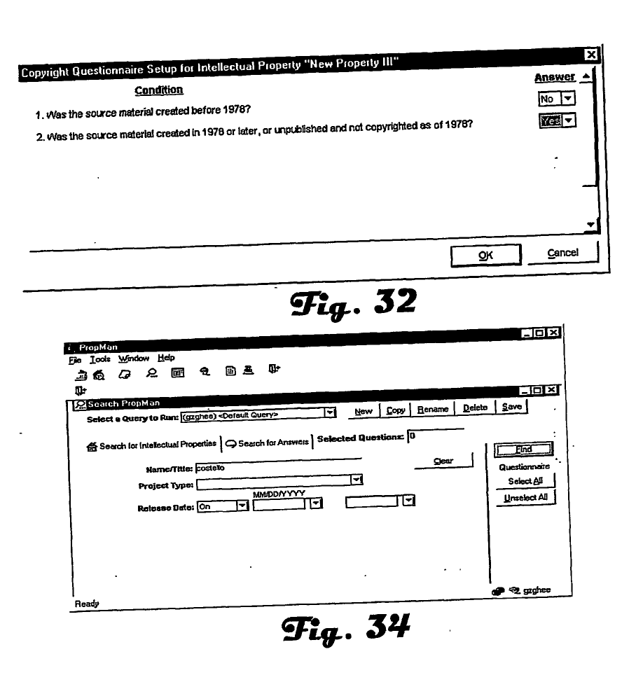

As shown in FIG. 31, some questions may have special format answers, for example requiring listing of territories or media. In such case, pull-down boxes listing possible choices, radio buttons, or similar programming techniques may be used to reduce error in entry and constrain the reviewer into a select group of choices. Additionally, optionally where answers are dependent and mutually exclusive, pull-down boxes and the like may be constrained to prevent inconsistent responses, or to allow branching to appropriate sub-parts. For example, as shown in FIG. 32, “yes” or “no” answers could be used to branch to avoid questions that would be irrelevant based upon the answer to the condition question.

Preferably, the interface that presents to the reviewer will have available hierarchical tree 60, so that navigation to the rights questionnaires to be answered may be easily done. Additionally, optionally the document checklist 38 may be made editable by the reviewer, so that an additional contract document 12 may be added as necessary, and the review module 16 may also permit attaching of additional rights questionnaire 10, or individuals.

Pertinent legal opinions could be identified by the attorney and referred to as part of the answers in the reports. The extent and scope of the legal opinions that could be rendered is variable within the system, and can be changed as the law changes. By way of example, legal opinions could be collected on the issues listed in Table 7.

TABLE 7
Copyright/Abend
Copyright/Authorship & Ownership
Copyright/Duration (U.S.)
Copyright/Duration (International Territories)
Copyright/Notice
Copyright/Publication
Copyright/Registration
Copyright/Renewal Formalities
Copyright/Termination
Guild Issues
Interpreting Scope of Grant
Use of Names and Likenesses In Merchandising and Commercial
Tie-Ins/Co-
Promotions

Other opinions could be added as evident to those skilled in the art, and as the system is modified to cover other intellectual property rights such as patent or trademark, similar opinions can be drafted. The list of opinions can be stored in a separate database in third memory 34, so that when answering a particular question in a report the reviewer can make reference to a legal opinion in a many to one data structure relationship. For example, an opinion on Guild Issues might be applicable to many answers, and can therefore be easily referenced in multiple report answers. The system permits a wide choice of access rights to such legal opinions, as detailed below, and in fact may alternatively choose not to include legal opinions on-line. In one embodiment, a company may choose to simply indicate that a legal opinion exists with respect to a certain issue, but maintain the opinion only in hard copy format under control of the legal department.

After the questions are answered, the process proceeds to step 116 where the reviewer prints the responses into hard copy as shown in exemplar samples in FIG. 5, FIG. 6 and FIG. 7. In step 118 the printed responses are reviewed and if an embodiment is used that stores responses in third memory 34, the system is updated. Alternatively, after electronically answering the questions in step 112, the reviewer can bypass printing step 116, and proceed directly to step 118 where the reviewer reviews the answers provided. The reviewer proceeds to step 120 where the intellectual property package 98, now containing responses 126, is electronically routed back to the contact person. Next, in step 122, the intellectual property package 98 is returned electronically and/or physically back to the company that sent the file to the contact point.

Alternatively, referring back to step 102 where the contact person receives the intellectual property package 98, the contact person is the legal analyst and the process proceeds directly to step 112 where the contact person addresses the issues raised in the reports. If the contact person is the legal analyst, then assigning step 104, testing step 106, and routing step 110 may be bypassed.

Referring back to testing step 106, if the intellectual property package 98 is not in electronic format, the process proceeds to routing step 108 where the package is physically routed to the reviewer. After receiving a hard copy of the package components, the reviewer in reviewing step 114, either manually enters the responses 126 onto the reports, or dictates the responses 126 onto tape. Such entries are entered or transcribed, as the case may entail, by either the reviewer or a secretary and printed in printing step 116. Optionally, in entering step 124 the responses 126 are entered into an electronic version of the one or more than one rights questionnaire 10 and stored in third memory 34. Once the responses 126 are in the system, the electronic version of the report is then electronically routed in reviewing step 118 to the reviewer for review, and the process proceeds as described above.

The system is dynamic rather than static. It is designed for flexibility. Part of that dynamism is aimed at keeping the legal analyses current. The legal opinions that are generated for the system can be updated or changed frequently to reflect changes in the law. The reviewer's job (whether inside or outside counsel) is to capture the factual information available in the legal files, and to complete a legal analysis based on the current state of the law. For each question for which an understanding of the law is required to see how the analyst reached a conclusion (or to see why the analyst could not reach a conclusion), the analyst is to identify all applicable Legal Opinions. As an independent attempt to ready particular titles for updating, the analysts are to quote pertinent grant language so that later, if the law changes, the company will be able to identify titles affected by such change.

The system is also designed to be flexible in terms of the information that it will capture, and make accommodation for addition of questions. This also allows creation of variations on the basic four summaries. For example, if users want to add questions to the Underlying Rights summary for the next section of titles analyzed, a new version of the summary can be created, leaving the current version intact. The new version of the summary need simply be stored in third memory 34 at both the law firm and the company, so that the new rights questionnaire 10 will appear in a described list of available rights questionnaires. As a further embodiment, if fewer questions on the summary for new projects is desired, another version of the summary for that purpose can be created. Further, a summary with entirely different questions can be created, for example, when the purpose of the analysis is to delineate the company's rights in a character rather than in either a particular film or source material for a particular film or films. This flexibility allows the system to respond to the needs of the users as well as to changing issues in the world of intellectual property rights.

In a further embodiment, it is possible to add a subscription module (not shown) so that users may be notified of changes. For example, if a user has previously reviewed a particular project and a change is made, the user will be notified if he has subscribed to the property.

Approval Module

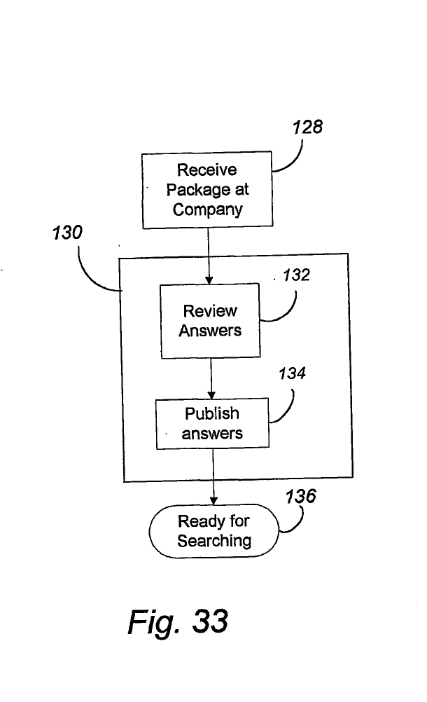

With reference to FIG. 33, in step receiving step 128 the intellectual property package 98 with responses 126 is received back at the company. If the review has been conducted internally, then this step may be omitted. Alternatively, both an electronic and a physical file can be received if some of the components of intellectual property package 98 with responses 126 are not in electronic format.

Approval procedure 130 preferably comprises a two step procedure of reviewing 132 the responses 126, and publishing 134 the responses 126. This approval procedure is desirable, although not necessary, as a quality check on the work of the analyst. It would be possible to omit the approval procedure 130, in which case the reviewed rights questionnaire 10 with the responses 126 would be stored in third memory 34 at the company, and be ready for searching and attaching to other projects or products immediately upon return to the company.

Reviewing step 132 may be partially automated, by searching for responses that may be inconsistent with answers to other questions. This permits system administrators to catch major errors in analysis as well as, perhaps, significant errors in form. For example, precluding the inputter from putting in answer x to Question 2 if the inputter has already answered Y to Question 1 will decrease inconsistency in the database, as noted above. This can be validated at the input stage in the review procedure, or in the approval procedure. Additionally, optionally it can be done from time to time by a system administrator to test the validity of the entire data. This can also help identify certain titles affected by changes in the law.

If approval procedure is implemented, reviewed rights questionnaire 10 with the responses 126 are not immediately stored in third memory 34, or if they are so stored, they are flagged or otherwise embargoed until the review step 132 is completed. The publishing step 134 entails removal of any embargo, or storage in third memory 34, as the case may be.

After approval procedure 130, the reviewed rights questionnaire 10 with the responses 126 are ready for searching, and attaching to other projects or products.

Search Module

Once responses 126 are stored in third memory 34, it is possible to search the data. In one preferred embodiment, a search may be done for specific intellectual properties, or for responses.

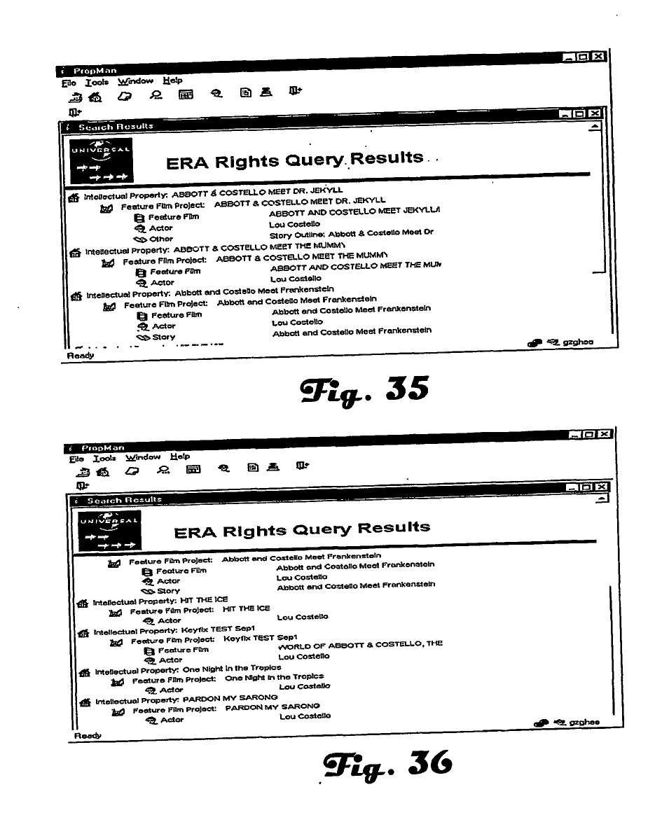

A window that may be used for searching is shown in FIG. 34. In the exemplar, entering “Costello” in the name/title box and initiating a search of data in third memory would yield a result as shown in FIG. 35 and FIG. 36, showing products and projects with “Costello” in the title, such as “Abbott and Costello Meet Frankenstein,” as well as products and projects in which Lou Costello was an actor. Note that the search result is shown as part of hierarchical tree 60 for the particular product and projects.

In similar fashion, it is possible to construct searches that are limited as to project type, such as those shown in Table 8:

TABLE 8

Feature Film
Movie of the Week
Old Anthology
Short Subject
Theme Park Ride
TV Mini Series
TV Other
TV Pilot
TV Series
TV Short Subject
TV Special
TV Stretchout
TV Talkshow
Unallocated

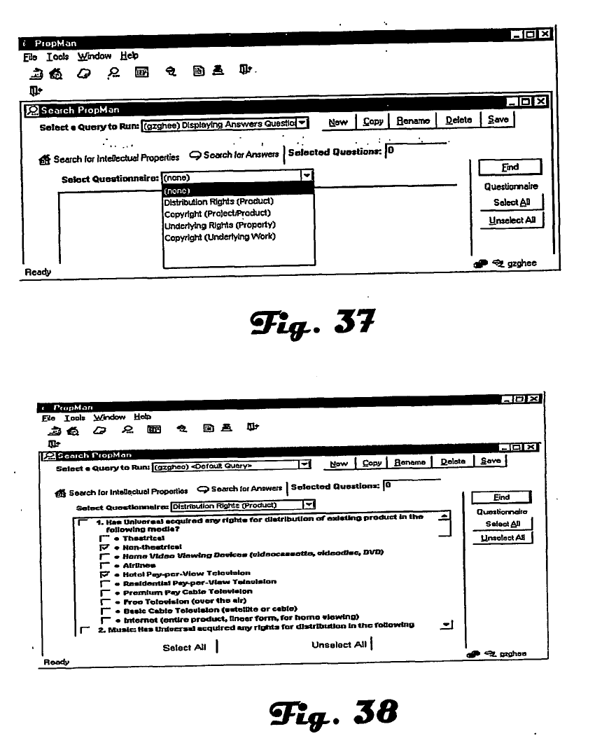

Release dates can be specified, or Boolean searches can be constructed. It is also possible in a preferred embodiment to search through rights questionnaires stored in third memory to find properties which have specified answers. In FIG. 34, clicking on the search for answers tab would bring up a new dialog box as shown in FIG. 37, and a drop down box listing categories of rights questionnaires to search. It is then possible to search one or more questions from one type of questionnaire, one or more questions from multiple questionnaire types, all questions from one questionnaire type, or all questions from all questionnaires. FIG. 38 shows a preferred embodiment where the question is displayed as part of check boxes.

In other embodiments it is possible to construct Boolean searches for specific words or phrases. For example, it might be desired to find all properties which have distribution rights in a specified foreign territory. This could be done by navigating to the appropriate question and checking a box, or by searching for the name of the territory in a text search.

It is further possible in a preferred embodiment to construct queries that can be saved, and run at later times.

Privilege

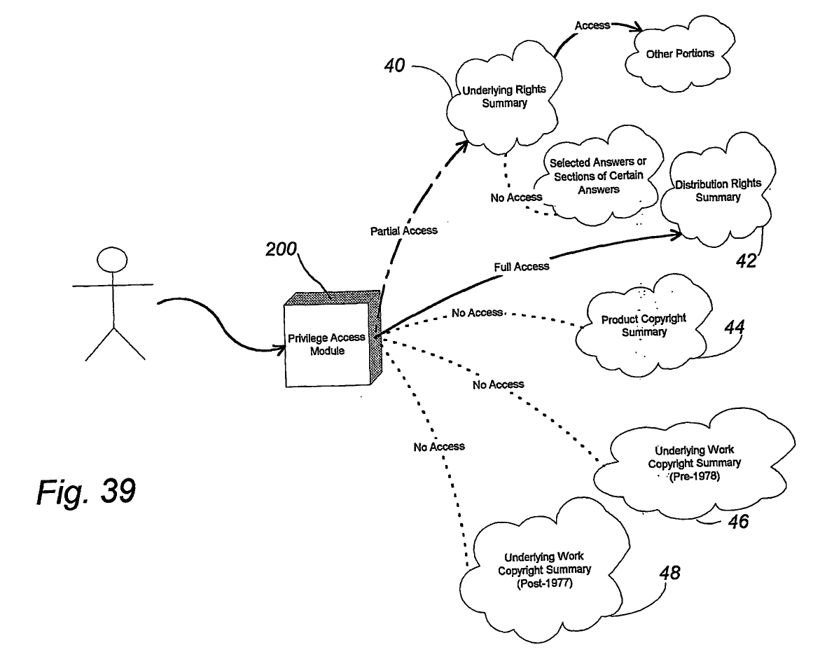

A company may consider that the entire information stored within the entire database is privileged, yet further determine that certain types of privileged information, such as counsel's analysis of an issue, will reside only within particular segments of the database. Selected disclosure of information in the resulting database is facilitated by the component structure of the rights summaries and is performed by a privilege access module 200, as shown in the object diagram of FIG. 39. In one embodiment, each user of the system is assigned a unique password and must sign in using such password, which is matched against stored information regarding the level of access permissible for that user. In another embodiment, each user is assigned a unique user name and must sign in using that user name. In yet another embodiment, there is one password for the system, and security rights are associated with each user name, which is presented at log-in. A further embodiment would permit capture of the user name from the operating system. Means to accomplish password protection and multi-level security for databases are well known in the art.

With the component structure of the rights data as taught herein, it becomes easy for the system to differentiate access, allowing access to information in an entire rights summary, or only partial access. The system also permits suppression of particular fields within answers. As shown in FIG. 39, a user with only limited access rights could be denied access to the Product Copyright Summary 44, Underlying Work Copyright Summary (Pre-1978) 46, and Underlying Work Copyright Summary (Post-1977) 48, and to certain answers or sections of certain answers within the Underlying Rights Summary 40, but allowed access to other portions of the Underlying Rights Summary 40 and to the entire Distribution Rights Summary 42. In another embodiment, legal opinions reside in the Copyright Summaries and the Document Checklists, and only attorneys acting in a legal capacity and employees working with and under the supervision of attorneys have access to those portions of the entire database. In that embodiment, the Underlying Rights Summaries and the Distribution Rights Summaries would be available to non-lawyers, who are otherwise permitted to access the database. In another embodiment, it is possible to limit access to particular fields within each record or only allow certain questions from each summary to be viewed. In such manner information can be controlled and limited to those persons within the organization that need access, avoiding any waiver or loss of legal privileges.

In another embodiment, certain portions of the data might be stored off line, and access controlled through physical means. This might be done with legal opinions, for example. In such event, one embodiment would indicate in the on-line portion of the system that such legal opinion exists.

The communications between the company and its in house personnel, and its outside counsel, as the case may be, can be conducted in any number of ways as is known in the art. One embodiment would be through e-mail systems such as Microsoft Outlook or Novell Groupwise, using the Internet or other local area network or wide area network. Files and communications could be encrypted using such schemes as PGP or equivalents. The database and program for implementing the system is stored on computer readable medium. Any currently existing or future developed computer readable medium suitable for storing data can be used, including, but not limited to hard drives, floppy disks, digital tape, flash cards, compact discs, and DVDs. The computer readable medium can comprise more than one device, such as two linked hard drives. Moreover, any server system that can exchange data with a user is suitable in the present invention. The exchange of data need not be through the World Wide Web/Internet, but can include, for example, direct user connections to the system such as by wireless, LAN line communications, or wireline communications, including a direct fiberoptic phone line. This invention is not limited to the particular hardware used herein, and any hardware presently existing or developed in the future that permits data transfer, storage, and running of database programs can be used.

In the foregoing specification, the invention has been described with reference to specific embodiments thereof. It will, however, be evident that various modifications and changes may be made thereto without departing from the broader spirit and scope of the invention. For example, it is possible to add similar questions and Summary modules to cover the areas of trademark and patent rights. Other embodiments are possible in which creation of personalized form reports are included within the system, reflecting the answers to specified questions. For example, a Remake Report can be added, which would reflect answers to those questions which are relevant to the issue of whether the company has the right to remake a certain film.

The system is readily adaptable to contract interpretation management as well as the application of copyright law and the right of publicity. For example, note the name and likeness questions on the Distribution Summary. Further enhancements can be made to cover neighboring/related rights issues, such as moral rights and performers' rights, and international as well as U.S. issues. Further questions can be added directed to information about union or Guild (e.g. SAG, WGA, and DGA) provisions that may affect the company's contractual rights. The specification and drawings are, accordingly, to be regarded in an illustrative rather than a restrictive sense. It should be appreciated that the present invention should not be construed as limited by such embodiments, but rather construed according to the below claims.

What is claimed is:

1. A system for managing intellectual property rights in an intellectual property arising from one or more than one contract document, comprising:
a central processing unit;
a display device coupled to the central processing unit;
one or more than one rights questionnaire posing one or more than one question pertaining to the intellectual property;
a first memory coupled to the central processing unit for storing a management program, the management program comprising:
a packaging module for packaging the one or more than one contract document and the one or more than one rights questionnaire;
a review module for directing review of the one or more than one contract document and acquisition of acquired responses to the one or more than one question posed in the one or more than one rights questionnaire; and
a search module to allow searching of the acquired responses;
a second memory coupled to the central processing unit for storing the one or more than one rights questionnaire; and
a third memory coupled to the central processing unit for storing the acquired responses.

2. The system of claim 1, the management program further comprising an approval module for permitting one or more than one review of the acquired responses.

3. The system of claim 1 wherein the rights questionnaire comprises one or more than one document checklist, one or more than one rights summary and one or more than one copyright summary.

4. The system of claim 3 wherein the one or more than one rights summary comprises one or more than one underlying rights summary and one or more than one distribution rights summary.

5. The system of claim 3 wherein the one or more than one copyright summary comprises one or more than one product copyright summary and one or more than one underlying work copyright summary.

6. The system of claim 1 wherein at least one rights questionnaire comprises at least one question arising under a law chosen from the group consisting of copyright laws, trademark laws, and patent laws.

7. The system of claim 1, the management program further comprising a privilege access module for controlling the disclosure of the acquired responses.

8. The system of claim 1, further comprising a fourth memory coupled to the central processing unit for storing the one or more than one contract document.

9. A system for managing intellectual property rights comprising a computer readable medium containing the management program of claim 1.

10. The system of claim 1 wherein the packaging module comprises:
an initialization module for initializing the system and creating one or more than one record having information pertaining to the intellectual property;
a linkage module for linking two or more records pertaining to the intellectual property to each other;
a generation module for generating the one or more than one appropriate rights questionnaire;
a routing module for sending the one or more than one contract document and the one or more than one generated rights questionnaire to the review module; and
a hierarchical tree to represent the linkage between the records.

11. The system of claim 10, the linkage module further for linking one or more than one record pertaining to the intellectual property to one or more than one record pertaining to other intellectual property.

12. The system of claim 10 wherein the management program stores the records created by the initialization module into a first database.

13. The system of claim 10 wherein the linkage module links one or more than one record to one or more than one rights questionnaire.

14. The system of claim 10 wherein a packager operates the packaging module, a reviewer operates the reviewing module and a searcher operates the search module.

15. The system of claim 14 wherein the packager and searcher are the same person.

16. The system of claim 14 wherein the reviewer is an attorney within in a corporate legal department.

17. The system of claim 14 wherein the reviewer is an attorney in an outside law firm.

18. The system of claim 10 wherein the generation module automatically generates one or more than one rights questionnaires when the initialization module creates one or more than one new record.

19. The system of claim 10 wherein the generation module offers a choice of rights questionnaires and generates the one or more than one rights questionnaires chosen.

20. A system for managing intellectual property rights in an intellectual property arising from one or more than one contract document, comprising:
means for central processing;
means for display coupled to the mean for central processing;
means for posing legal questions pertaining to the intellectual property;
means for storing a management program coupled to the means for central processing, the management program comprising:
means for packaging the one or more than one contract document and the legal questions;
means for reviewing the one or more than one contract document and acquiring acquired responses to the legal questions; and
means for searching the acquired responses.

21. A method for managing intellectual property rights in an intellectual property arising from one or more than one contract document, comprising the steps of:
packaging the one or more than one contract document and pertinent legal questions comprising one or more than one legal question pertaining to the intellectual property;
directing the review of the one or more than one contract document and acquisition of acquired responses to the pertinent legal questions; and
storing the acquired responses in a database to permit searching the acquired responses.

22. The method of claim 21 wherein the packaging step comprises the steps of:
initializing a management program and creating data records comprising one or more than one data record having information pertaining to the intellectual property;
generating the pertinent legal questions;
linking the data records to the pertinent legal questions;
displaying a hierarchical tree representing the linkage between the data records and the pertinent legal questions; and
routing the one or more than one contract document, the pertinent legal questions, and the data records to the review module.

23. The method of claim 22 wherein the generating step comprises offering choice of rights questionnaires, receiving a request for one or more than one rights questionnaire, and generating the one or more than one rights questionnaire requested.

24. The method of claim 22 wherein the generating step comprises automatically generating one or more than one rights questionnaire based upon the information in the data records.

25. The method of claim 21, further comprising, before the packaging step, preparing one or more than one rights questionnaire having one or more than one question designed to elicit critical information about ownership rights in intellectual property.

26. The method of claim 21 wherein the directing step comprises sending the one or more than one contract document to a legal source for review and receiving acquired responses to the pertinent legal questions.

27. A method for managing intellectual property rights in an intellectual property arising from one or more than one contract document, comprising the steps for:
central processing and display of information pertinent to the intellectual property;
posing legal questions pertaining to the intellectual property;
storing a management program used in the central processing and display step, the management program comprising the steps for:
packaging the one or more than one contract document and the legal questions;
reviewing the one or more than one contract document and acquiring acquired responses to the legal questions; and
searching the acquired responses.

28. A method for managing ownership rights in an intellectual property arising from one or more than one contract document, comprising the steps of, under the control of a user system:
accessing a computer network;
initializing a management program and creating data records and preparing a package having one or more than one rights questionnaire and the one or more than one contract document;
routing the package for review, the rights questionnaire having one or more than one question; and
receiving a reviewed rights questionnaire having responses to the one or more than one question and storing the responses in a database.

29. The method of claim 28 further comprising the step of searching the responses stored in the database.

30. A signal for transmitting computer information through a computer network for causing a computer-based information handling system to perform steps for managing ownership rights in an intellectual property arising from one or more than one contract document, the steps comprising:
packaging the one or more than one contract document and pertinent legal questions comprising one or more than one legal question pertaining to the intellectual property;
directing the review of the one or more than one contract document and acquisition of acquired responses to the pertinent legal questions; and
storing the acquired responses in a database to permit searching the acquired responses.
